(19) United States
(12) Patent Application Publication
(10) Pub. No.: US 2024/0307830 A1
(43) Pub. Date: Sep. 19, 2024

(54) THERMAL DIFFUSION MEMBRANE, DEVICES SYSTEMS AND METHODS

(71) Applicant: Daniel P. Sheehan, San Diego, CA (US)

(72) Inventor: Daniel P. Sheehan, San Diego, CA (US)

(21) Appl. No.: 18/274,969

(22) PCT Filed: Feb. 1, 2022
(86) PCT No.: PCT/US2022/014775

§ 371 Date: Jul. 28, 2023

Related U.S. Application Data
(60) Provisional application No. 63/144,650, filed on Feb. 2, 2021.

(51) Int. Cl. B01D 69/14; B01D 61/44; B01D 69/02; B01D 71/36; H01M 14/00

(52) U.S. Cl. CPC B01D 69/1411; B01D 61/445; B01D 69/02; B01D 71/36; H01M 14/00; B01D 2325/022

(57) ABSTRACT

The present disclosure provides various embodiments of asymmetric thermal diffusion membranes, devices, systems, and methods. Chemically asymmetric membranes comprise chemical potential gradients allowing for thermally driven asymmetrical diffusion of chemical species. Devices and systems may comprise thermally driven chemically asymmetric membranes and to utilize thermal ambient energy for chemical separation, concentration, dilution as well as for energy generation and storage.

### CROSS REFERENCE

This application claims the benefit of U.S. Provisional Application No. 63/144,650, filed on Feb. 2, 2021, which is incorporated herein by reference in its entirety.

### BACKGROUND

Separation of chemical species can be accomplished through the use of chemical membranes. Membranes are selective barriers found throughout the biological, chemical, and industrial spheres. All biologic cells involve membranes both at their boundaries and around organelles within them (e.g., nuclei, mitochondria). Membranes may also exhibit selective permeability, which allows them to transport, sequester, concentrate, store, and expel specific chemical species from cellular regions so as to support life processes. Membranes are nanometers to microns in thickness and are complex entities, usually riven with such things as ion gates, anchors, protein receptors, and other microchemical machines. Their activities may be driven by chemical or photonic free energy sources provided by or extracted from the cell's environment. Additionally, chemical membranes may be used in a broad range of industrial applications including water and air filtration, chemical processing, and fuel cell technology, among other fields of use.

### SUMMARY

Described herein are various embodiments, of a membrane comprising: a matrix; a plurality of binding sites, attached to, or contained within, said matrix, wherein said plurality of binding sites are configured to bind a chemical species, and wherein said matrix or said plurality of binding sites form a chemical potential gradient, and wherein said chemical potential gradient is configured to transport said chemical species in a net direction along said axis of flow via thermal diffusion. In some embodiments, further comprising a matrix a porosity of about 1% to about 90%; a pore diameter of about 10⁻⁸ m to about 10⁻⁴ m; and a thickness of about 10⁻⁹ m to about 10⁻² m. In some embodiments, an aspect ratio is defined as the ratio of the thickness to the pore diameter. In some embodiments, said aspect ratio is between about 1:1 to about 1000:1. In some embodiments, said aspect ratio is between about 10:1 to about 100:1. In some embodiments, said matrix or plurality of binding sites is configured to transport said chemical species in a net direction along said axis of flow via thermal diffusion driven by ambient thermal energy, ambient temperature of said surroundings, or a combination thereof. In some embodiments, said matrix and said plurality of binding sites are configured to provide a chemical potential gradient. In some embodiments, said matrix and said plurality of binding sites are arranged to provide a chemical potential gradient. In some embodiments, said matrix, said plurality of said binding sites, and a free energy value of each binding site of said plurality forms a chemical potential gradient. In some embodiments, said free energy value of each binding site of said plurality depends, in part, from a composition of said each binding site of said plurality. In some embodiments, said composition of said each binding site of said plurality is comprised of R—N(CH₃)₃, R—SO₃, R—PO₃H⁻, R═NH, —NH₂, R—COO⁻, R—PO₃−, where R is said matrix or said membrane. In some embodiments, said chemical potential gradient is non-zero, and the chemical potential varies in a linear, exponential, sigmoidal, stepwise, or polynomial fashion, or a combination thereof along said axis of flow. In some embodiments, a maximum binding site number density is between about 10¹² per m² to about 10¹⁹ per m². In some embodiments, said maximum binding site number density is about 10¹⁸ per m². In some embodiments, said matrix or said plurality of binding sites is configured to generate a concentration differential of one or more chemical species. In some embodiments, said matrix or said plurality of binding sites is configured to create one or more concentration differentials of one or more chemical species present in one or more or more solutions. In some embodiments, at least one solution of said one or more solutions is liquid phase, solid phase, gas phase, or a combination thereof. In some embodiments, said one or more solutions are aqueous, non-aqueous or a combination thereof. In some embodiments, said matrix or said plurality of binding sites is configured to concentrate or dilute a chemical species. In some embodiments, said matrix or said plurality of binding sites is configured to allow diffusion of said chemical species comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺), ammonium ion (NH₄⁺), (Cl—), fluoride (F⁻), bromide (Br⁻), hydroxide (OH⁻), cyanide (CN⁻), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻), hypochlorite (ClO⁻), or a combination thereof. In some embodiments, said matrix or said plurality of binding sites is configured to concentrate one or more electrically neutral chemical species in said one or more solution. In some embodiments, said one or more electrically neutral chemical species comprises a sugar, a protein, a carbohydrate, a fat, or an amino acid. In some embodiments, said matrix or said plurality of binding sites is configured to desalinate water. In some embodiments, said matrix or said plurality of binding sites comprises one or more planar sub-membranes. In some embodiments, said matrix or said plurality of binding sites comprises one or more cylindrical sub-membranes. In some embodiments, said matrix or said plurality of binding sites comprises a 2D material. In some embodiments, said 2D material is chemically functionalized differently on each side. In some embodiments, said matrix or said plurality of binding sites comprises two or more layers of said 2D material, wherein said 2D material is chemically functionalized differently either internally or on outer sides. In some embodiments, said 2D material comprises graphene, stanene, hexagonal boron nitride, molybdenum disulfide, graphyne, borophene, germanene, silicene plumbene, phosphorene, antimonene, bismuthine, metals, or a combination thereof. In some embodiments, said matrix or said plurality of binding sites comprises a 3D material. In some embodiments, said matrix or said plurality of binding sites comprises two or more layers of said 3D material chemically functionalized differently within one or more volumes of each individual layer. In some embodiments, said 3D material comprises one or more members selected from the group consisting of: Nafion™, dendrimers, ionomers, organic and inorganic polymers. In some embodiments, said matrix or plurality of binding sites is incorporated into a concentration cell. In some embodiments, said matrix or said plurality of binding sites comprises one or more chemical potential gradients. A system comprising said membrane of any one of said embodiments. A system of any one of said embodiments, wherein at least one additional membrane is arranged in series with said membrane. A system of any one of said embodiments, wherein said at least one additional membrane is arranged in parallel with said membrane. A system of any one of said embodiments, wherein said at least one additional membrane comprises at least one membrane, wherein said at least two membranes are arranged in series, in parallel, or in a combination thereof. A system of any one of said embodiments, wherein said membrane is arranged in between a first reservoir of one or more reservoirs and a second reservoir of said one or more reservoirs. A system of any one of said embodiments, wherein said membrane is arranged in between said first reservoir of said one or more reservoirs and said second reservoir of said one or more reservoirs, and wherein said at least one additional membrane is arranged between said second reservoir and a third reservoir of said one or more reservoirs.

Described herein are various embodiments, of a device comprising: one or more reservoirs comprising: a first reservoir configured to receive a first solution comprising a chemical species; a second reservoir comprising a second solution configured to receive said chemical species; one or more membranes, wherein at least one membrane of said one or more membranes comprises a chemical potential gradient, wherein said chemical potential gradient is non-zero along an axis of flow of said membrane, and wherein said membrane is located between and in contact with at least said first and second reservoir, and wherein said matrix or plurality of binding sites is configured to transport said chemical species in a net direction along said axis of flow via thermal diffusion. In some embodiments, the device further comprises a differential concentration, wherein said first reservoir comprises said chemical species at a first concentration value and said second reservoir comprises said chemical species at a second concentration value, wherein said first concentration value is not equal to said second concentration value. In some embodiments, one or more membranes are configured generate said equilibrium state via thermally driven diffusion of said chemical species. In some embodiments, said chemical species comprises an ion. In some embodiments, the device further comprises a counter ion. In some embodiments, said device does not comprising a salt bridge. In some embodiments, said binding sites are configured to bind with said counter ion. In some embodiments, said binding sites are configured to bind to said counter ion and transport both counter ion and said ion. In some embodiments, at least one additional membrane is arranged in series with said membrane. In some embodiments, said at least one additional membrane is arranged in parallel with said membrane. In some embodiments, said at least one additional membrane comprises at least two membranes, wherein said at least two membranes are arranged in series, in parallel, or in a combination thereof. In some embodiments, said at least one additional membrane is arranged between said second reservoir and at least a third reservoir of said one or more reservoirs. In some embodiments, said membrane further comprises a matrix a porosity of about 1% to about 90%; a pore diameter of about 10⁻⁸ m to about 10⁻⁴ m; and a thickness of about 10⁻⁹ m to about 10⁻² m. In some embodiments, an aspect ratio is defined as said ratio of said thickness of said matrix to said pore diameter. In some embodiments, said aspect ratio is between about 1:1 to about 1000:1. In some embodiments, said aspect ratio is between about 10:1 to about 100:1. In some embodiments, said matrix or plurality of binding sites is configured to transport said chemical species in a net direction along said axis of flow via thermal diffusion driven by ambient thermal energy, ambient temperature of said surroundings, or a combination thereof. In some embodiments, said matrix and said plurality of binding sites are configured to provide a chemical potential gradient. In some embodiments, said matrix and said plurality of binding sites are arranged to provide a chemical potential gradient. In some embodiments, said matrix, said plurality of said binding sites, and a free energy value of each binding site of said plurality forms a chemical potential gradient. In some embodiments, said free energy value of each binding site of said plurality depends, in part, from a composition of said each binding site of said plurality. In some embodiments, said composition of said each binding site of said plurality is comprised of R—N(CH₃)₃, R—SO₃, R—PO₃H⁻, R═NH, —NH₂, R—COO⁻, R—PO₃−, where R is said matrix or said membrane. In some embodiments, said chemical potential gradient is non-zero, and the chemical potential varies in a linear, exponential, sigmoidal, stepwise, or polynomial fashion, or a combination thereof along said axis of flow. In some embodiments, a maximum binding site number density is between about 10¹² per m² to about 10¹⁹ per m². In some embodiments, said maximum binding site number density is about 10¹⁸ per m². In some embodiments, said matrix or said plurality of binding sites is configured to generate a concentration differential of one or more chemical species. In some embodiments, said matrix or said plurality of binding sites is configured to create one or more concentration differentials of said one or more chemical species present in one or more or more solutions. In some embodiments, at least one solution of said one or more solutions is liquid phase, solid phase, gas phase, or a combination thereof. In some embodiments, said one or more solutions are aqueous, non-aqueous or a combination thereof. In some embodiments, said matrix or said plurality of binding sites is configured to concentrate or dilute a chemical species. In some embodiments, said matrix or said plurality of binding sites is configured to allow diffusion of said chemical species comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺), ammonium ion (NH₄⁺), (Cl—), fluoride (F⁻), bromide (Br⁻), hydroxide (OH⁻), cyanide (CN⁻), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻), hypochlorite (ClO⁻), or a combination thereof. In some embodiments, said matrix or said plurality of binding sites is configured to concentrate one or more electrically neutral chemical species in said one or more solution. In some embodiments, said one or more electrically neutral chemical species comprises a sugar, a protein, a carbohydrate, a fat, or an amino acid. In some embodiments, said matrix or said plurality of binding sites is configured to desalinate water. In some embodiments, said matrix or said plurality of binding sites comprises one or more planar sub-membranes. In some embodiments, said matrix or said plurality of binding sites comprises one or more cylindrical sub-membranes. In some embodiments, said matrix or said plurality of binding sites comprises a 2D material. In some embodiments, said 2D material is chemically functionalized differently on each side. In some embodiments, said matrix or said plurality of binding sites comprises two or more layers of said 2D material, wherein said 2D material is chemically functionalized differently either internally or on outer sides. In some embodiments, said 2D material comprises graphene, stanene, and hexagonal boron nitride, molybdenum disulfide, graphyne, borophene, germanene, silicene plumbene, phosphorene, antimonene, bismuthine, metals, or a combination thereof. In some embodiments, said matrix or said plurality of binding sites comprises a 3D material. In some embodiments, said matrix or said plurality of binding sites comprises two or more layers of said 3D material chemically functionalized differently within one or more volumes of each individual layer. In some embodiments, said 3D material comprises Nafion™, dendrimers, ionomers, organic and inorganic polymers, or a combination thereof. In some embodiments, said matrix or plurality of binding sites is incorporated into a concentration cell. In some embodiments, said matrix or said plurality of binding sites comprises one or more chemical potential gradients. In some embodiments, said device comprises at least one commercially available bipolar membrane. In some embodiments, said at least one commercially available bipolar membrane comprises a Fumasep™ bipolar membrane or a Xion™ bipolar membrane.

Described herein are various embodiments, of a device comprising: one or more reservoirs comprising: a first reservoir configured to receive a first solution comprising a chemical species; a second reservoir comprising a second solution configured to receive said chemical species; one or more membranes, wherein at least one membrane of said one or more membranes comprises a chemical potential gradient, wherein said chemical potential gradient is non-zero along an axis of flow of said membrane, and wherein said one or more membranes is located between and in contact with at least said first and second reservoir, and wherein said matrix or plurality of binding sites is configured to transport said chemical species in a net direction along said axis of flow via thermal diffusion; and a first electrode in contact with said first reservoir and a second electrode in contact with said second reservoir; and wherein said first and second electrode are configured to exhibit an electrical potential difference upon transport said chemical species in a net direction along said axis of flow via thermal diffusion. In some embodiments, an equilibrium state, wherein said first reservoir comprises said ion at a first concentration value and said second reservoir comprises said ion at a second concentration value, wherein said first concentration value is not equal to said second concentration value. In some embodiments, said one or more membranes are configured generate said equilibrium state via thermally driven diffusion of said ion. In some embodiments, said thermal energy is ambient thermal energy. In some embodiments, said first electrode is located in said first reservoir and said second electrode is located in said second reservoir. In some embodiments, said chemical species comprises an ion, a counter ion, or a combination thereof. In some embodiments, said plurality of binding sites is configured to bind said ion and wherein said chemical species is said counter ion of said ion.

In some embodiments, the device does not comprise a salt bridge. In some embodiments, at least one additional membrane is arranged in series with said membrane. In some embodiments, said at least one additional membrane is arranged in parallel with said membrane. In some embodiments, said at least one additional membrane comprises at least two membranes, wherein said at least two membranes are arranged in series, in parallel, or in a combination thereof. In some embodiments, said at least one additional membrane is arranged between said second reservoir and at least a third reservoir of said one or more reservoirs. In some embodiments, said device further comprises a matrix a porosity of about 1% to about 90%; a pore diameter of about 10⁻⁸ m to about 10⁻⁴ m; and a thickness of about 10⁻⁹ m to about 10⁻² m. In some embodiments, an aspect ratio is defined as said ratio of said thickness to said pore diameter. In some embodiments, said aspect ratio is between about 1:1 to about 1000:1. In some embodiments, said aspect ratio is between about 10:1 to about 100:1. In some embodiments, said matrix or plurality of binding sites is configured to transport said chemical species in a net direction along said axis of flow via thermal diffusion driven by ambient thermal energy, ambient temperature of said surroundings, or a combination thereof. In some embodiments, said matrix and said plurality of binding sites are configured to provide a chemical potential gradient. In some embodiments, said matrix and said plurality of binding sites are arranged to provide a chemical potential gradient. In some embodiments, said matrix, said plurality of said binding sites, and a free energy value of each binding site of said plurality forms a chemical potential gradient. In some embodiments, said free energy value of each binding site of said plurality depends, in part, from a composition of said each binding site of said plurality. In some embodiments, said composition of said each binding site of said plurality is comprised of R—N(CH₃)₃, R—SO₃, R—PO₃H⁻, R═NH, —NH₂, R—COO⁻, R—PO₃⁻, where R is said matrix or said membrane. In some embodiments, said chemical potential gradient is non-zero, and the chemical potential varies in a linear, exponential, sigmoidal, stepwise, or polynomial fashion, or a combination thereof along said axis of flow. In some embodiments, the device further comprises a maximum binding site number density between about 10¹² per m² to about 10¹⁹ per m². In some embodiments, said maximum binding site number density is about 10¹⁸ per m². In some embodiments, said matrix or said plurality of binding sites is configured to generate a concentration differential of one or more chemical species. In some embodiments, said matrix or said plurality of binding sites is configured to generate one or more concentration differentials of one or more chemical species present in one or more or more solutions. In some embodiments, at least one solution of said one or more solutions is liquid phase, solid phase, gas phase, or a combination thereof. In some embodiments, said one or more solutions are aqueous, non-aqueous or a combination thereof. In some embodiments, said matrix or said plurality of binding sites is configured to concentrate or dilute a chemical species. In some embodiments, said matrix or said plurality of binding sites is configured to allow diffusion of said chemical species comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺), ammonium ion (NH₄⁺), (Cl—), fluoride (F⁻), bromide (Br⁻), hydroxide (OH⁻), cyanide (CN), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻), hypochlorite (ClO⁻), or a combination thereof. In some embodiments, said matrix or said plurality of binding sites is configured to concentrate or dilute one or more electrically neutral chemical species in said one or more solution. In some embodiments, said one or more electrically neutral chemical species comprises a sugar, a protein, a carbohydrate, a fat, or an amino acid. In some embodiments, said matrix or said plurality of binding sites is configured to desalinate water. In some embodiments, said matrix or said plurality of binding sites comprises one or more planar sub-membranes. In some embodiments, said matrix or said plurality of binding sites comprises one or more cylindrical sub-membranes. In some embodiments, said matrix or said plurality of binding sites comprises a 2D material. In some embodiments, said 2D material is chemically functionalized differently on each side. In some embodiments, said matrix or said plurality of binding sites comprises two or more layers of said 2D material, wherein said 2D material is chemically functionalized differently either internally or on outer sides. In some embodiments, said 2D material comprises graphene, stanene, hexagonal boron nitride, molybdenum disulfide, graphyne, borophene, germanene, silicene plumbene, phosphorene, antimonene, bismuthine, metals, or a combination thereof. In some embodiments, said matrix or said plurality of binding sites comprises a 3D material. In some embodiments, said matrix or said plurality of binding sites comprises two or more layers of said 3D material chemically functionalized differently within one or more volumes of each individual layer. In some embodiments, said 3D material comprises Nafion™ dendrimers, ionomers, organic, inorganic polymers, or a combination thereof. In some embodiments, said matrix or plurality of binding sites is incorporated into a concentration cell. In some embodiments, said matrix or said plurality of binding sites comprises one or more chemical potential gradients. In some embodiments, said device comprises at least one commercially available bipolar membrane. In some embodiments, said at least one commercially available bipolar membrane comprises a Fumasep™ bipolar membrane or a Xion™ bipolar membrane.

Described herein are various embodiments of a method comprising: obtaining a first and second reservoir of two or more reservoirs and a membrane of one or more membranes, wherein said membrane is in between said first and second reservoir, and wherein said membrane comprises a matrix or plurality of binding sites that are configured to transport a chemical species in a net direction along an axis of flow via thermal diffusion; obtaining a solution comprising a first concentration of said chemical species of at least one chemical species; allowing movement of said chemical species across said membrane to said second reservoir, and wherein said movement of said chemical species is thermally driven toward an equilibrium state, wherein said chemical species, located in said second reservoir comprises a second concentration value, and wherein said first concentration value is not equal to said second concentration value. In some embodiments, the method further comprises obtaining a first electrode in contact with said first reservoir and a second electrode in contact with said second reservoir, and further allowing an electrical potential difference to form between said first electrode and said second electrode at said equilibrium state. In some embodiments, said first electrode and said second electrode are located in said first and said second reservoir. In some embodiments, said membrane further comprises a matrix a porosity of about 1% to about 90%; a pore diameter of about 10⁻⁸ m to about 10⁻⁴ m; and a thickness of about 10⁻⁹ m to about 10⁻² m. In some embodiments, an aspect ratio is defined as said ratio of said thickness to said pore diameter. In some embodiments, said aspect ratio is between about 1:1 to about 1000:1. In some embodiments, said aspect ratio is between about 10:1 to about 100:1. In some embodiments, said matrix or plurality of binding sites is configured to transport said chemical species in a net direction along said axis of flow via thermal diffusion driven by ambient thermal energy, ambient temperature of said surroundings, or a combination thereof. In some embodiments, said matrix and said plurality of binding sites are configured to provide a chemical potential gradient. In some embodiments, said matrix and said plurality of binding sites are arranged to provide a chemical potential gradient. In some embodiments, said matrix, said plurality of said binding sites, and a free energy value of each binding site of said plurality forms a chemical potential gradient. In some embodiments, said free energy value of each binding site of said plurality depends, in part, from a composition of said each binding site of said plurality. In some embodiments, said composition of said each binding site of said plurality is comprised of R—N(CH₃)₃, R—SO₃, R—PO₃H⁻, R═NH, —NH₂, R—COO⁻, R—PO₃⁻, where R is said matrix or said membrane. In some embodiments, said chemical potential gradient is non-zero, and the chemical potential varies in a linear, exponential, sigmoidal, stepwise, or polynomial fashion, or a combination thereof along said axis of flow. In some embodiments, a maximum binding site number density is between about 10¹² per m² to about 10¹⁹ per m². In some embodiments, said maximum binding site number density is about 10¹⁸ per m². In some embodiments, said matrix or said plurality of binding sites is configured to generate a concentration differential of one or more chemical species. In some embodiments, said matrix or said plurality of binding sites is configured to create one or more concentration differentials of one or more chemical species present in one or more or more solutions. In some embodiments, at least one solution of said one or more solutions is liquid phase, solid phase, gas phase, or a combination thereof. In some embodiments, said one or more solutions are aqueous, non-aqueous or a combination thereof. In some embodiments, said matrix or said plurality of binding sites is configured to concentrate or dilute a chemical species. In some embodiments, said matrix or said plurality of binding sites is configured to allow diffusion of said chemical species comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺), ammonium ion (NH₄⁺), (Cl—), fluoride (F—), bromide (Br⁻), hydroxide (OH⁻), cyanide (CN⁻), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻), hypochlorite (ClO⁻), or a combination thereof. In some embodiments, said matrix or said plurality of binding sites is configured to concentrate one or more electrically neutral chemical species in said one or more solution. In some embodiments, said one or more electrically neutral chemical species comprises a sugar, a protein, a carbohydrate, a fat or an amino acid. In some embodiments, said matrix or said plurality of binding sites is configured to desalinate water. In some embodiments, said matrix or said plurality of binding sites comprises one or more planar sub-membranes. In some embodiments, said matrix or said plurality of binding sites comprises one or more cylindrical sub-membranes. In some embodiments, said matrix or said plurality of binding sites comprises a 2D material. In some embodiments, said 2D material is chemically functionalized differently on each side. In some embodiments, said matrix or said plurality of binding sites comprises two or more layers of said 2D material, wherein said 2D material is chemically functionalized differently either internally or on outer sides. In some embodiments, said 2D material comprises graphene, stanene, hexagonal boron nitride, molybdenum disulfide, graphyne, borophene, germanene, silicene plumbene, phosphorene, antimonene, bismuthine, metals, or a combination thereof. In some embodiments, said matrix or said plurality of binding sites comprises a 3D material. In some embodiments, said matrix or said plurality of binding sites comprises two or more layers of said 3D material chemically functionalized differently within one or more volumes of each individual layer. In some embodiments, said 3D material comprises Nafion™, dendrimers, ionomers, organic, inorganic polymers, or a combination thereof. In some embodiments, said matrix or plurality of binding sites is incorporated into a concentration cell. In some embodiments, said matrix or said plurality of binding sites comprises one or more chemical potential gradients.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A shows a non-limiting schematic for a device comprising a chemically asymmetric membrane (CAM) located between reservoirs in accordance with some embodiments. FIG. 1B shows a non-limiting cross-section of the CAM. FIG. 1C shows a cross section of a pore within the CAM, where binding sites, B, form a gradient of increasing number density from left to right, in accordance with some embodiments.

FIG. 2 shows a non-limiting schematic for a device comprising a chemically asymmetric membrane configured as a thermal diffusion driven battery, in accordance with some embodiments.

FIG. 3A shows a non-limiting schematic of a thermal diffusion diode cell (e.g., concentration cell) configured to transport hydronium ion, in accordance with some embodiments. FIG. 3B shows a plot of solution pH versus total hydrogen ion load (N_{H}).

FIG. 4A shows non-limiting schematic for a single-membrane hydronium ion diffusion diode (HDD) cell, according to some embodiments. FIG. 4B shows non-limiting schematic for a three-membrane series HDD diffusion cell, in accordance with some embodiments. FIG. 4C shows an electrochemical cell, in accordance with some embodiments.

FIG. 5 shows a plot of pH vs. time for a single-membrane hydronium diffusion diode.

FIG. 6 shows plot of pH versus time (hr) for reservoirs in the three-membrane series HDD as shown in FIG. 4B.

FIG. 7 shows a plot of AgCl emf (mV) vs. pH.

FIG. 8 shows non-limiting a schematic of a thermally driven diffusion diode device in a parallel configuration, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed

### INTRODUCTION

Synthetic membranes, ones produced by humans, are used in many technological strata from households (e.g., osmotic membranes) to industrial (e.g., chloroalkali synthesis, chemical fuel cells). For separation processes membranes can operate without heat generation, therefore they can use less energy than separation processes like crystallization and distillation. Example membrane operations include: micro- and ultrafiltration, reverse osmosis, gas separation, dialysis, evaporation, forward osmosis, artificial lungs, electrodialysis, membrane electrolysis, electro-deionization, electro-filtration, fuel cells, and membrane distillation. In some examples, membrane operations may use external energy sources to drive the underlying chemical or physical separation of products. In some examples, materials, devices, systems, and methods described herein may operate using ambient thermal energy.

Devices, systems, and methods of the present disclosure provide a class of chemical membranes and their use that may asymmetrically segregate atomic or molecular species in such a way as to allow species concentration differences between the two sides of the membrane to arise in a thermodynamically cyclic manner. In some examples, the energy for species separation is provided by ambient thermal energy. In some examples, the primary transport mechanism is diffusion.

The present disclosure provides materials, devices, systems, and methods for the separation, concentration, and dilution of chemical species. Additionally, the materials, devices, systems, and methods of the present disclosure can be implemented using devices that are configured for the generation and storage of electrical power. In some embodiments the materials described herein are referred to thermally driven chemically asymmetric membranes. Such thermally driven chemically asymmetric membranes allow for net flow of a chemical species, in one direction, along an axis of flow across the membrane. Such membranes can be referred to as diffusion diodes. In some examples, devices can be configured as thermally driven concentration cells. In some examples, thermally driven diffusion diodes are referred as concentration cells. In some examples, the devices can be configured as batteries utilizing thermally driven diffusion diodes. The devices provided herein can be used to perform in a single integrated system.

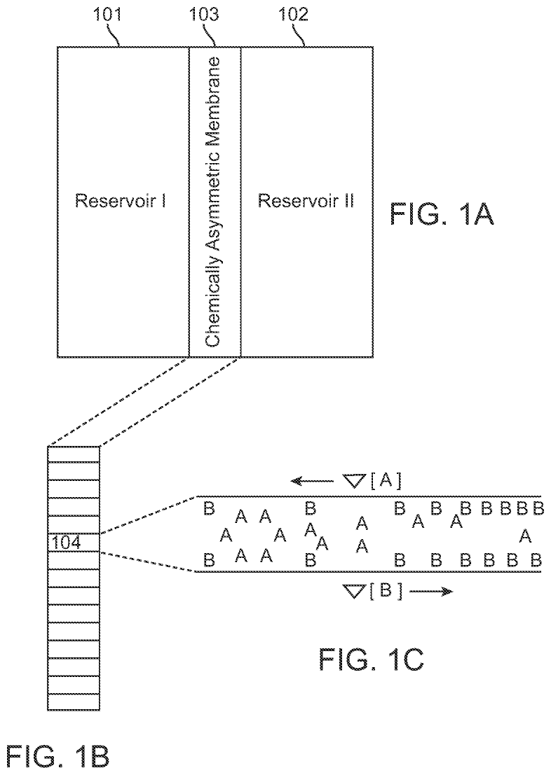

FIGS. 1A-1C show a non-limiting schematic for a device comprising a chemically asymmetric membrane (CAM), in accordance with some embodiments. FIG. 1B shows a cross-section of the CAM. FIG. 1C displays a magnified inset of the cross-section of the CAM shown in FIG. 1B. FIG. 1A shows the device comprising a chemically asymmetric membrane 103, a first 101 and second reservoir 102. FIG. 1C shows a pore 104 of the CAM comprising chemical species A and B. Chemical species, B, is shown to be immobilized to the walls of the pore 104. In some examples, the concentration, or number density of B, shown as [B], increases from left to right, forming a concentration gradient of B. In some examples, the concentration gradient of B is referred to as the number density gradient of B. In some examples, chemical species A may diffuse throughout the pore, with a net direction to the left, which is driven by the chemical gradient and ambient thermal energy, as shown in FIG. 1C. This net flow which is achieved at equilibrium allows for a concentration differential to form, for chemical species A, between the first and second reservoir at equilibrium.

The following is provided for the purpose of illustrating various principles related to devices, systems, and methods disclosed here and is not meant to limit the present invention in any fashion.

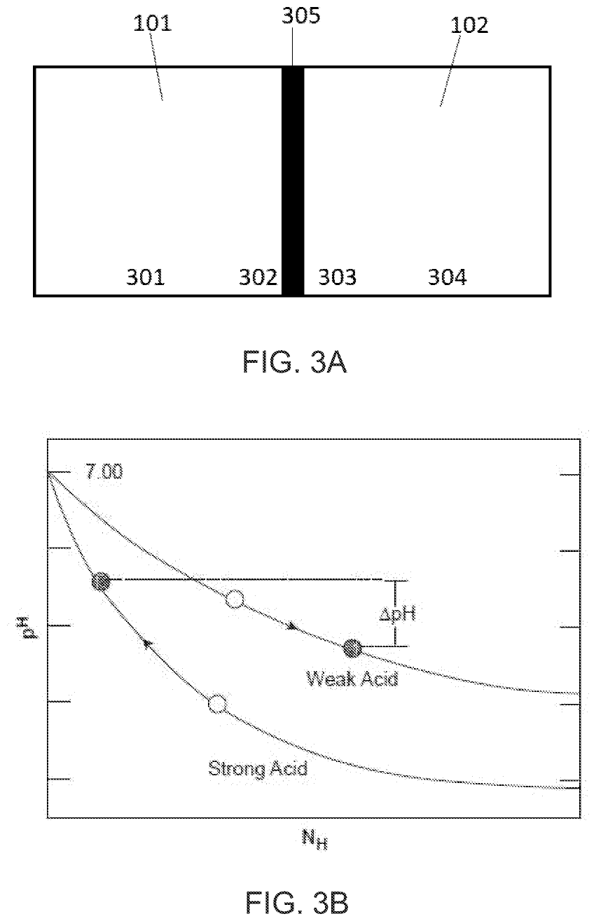

For some examples, consider two reservoirs 101 and 102 FIG. 3A, separated by a thin, removable partition 305 running between them, with walls coated with different chemical solids and filled with an identical isotonic solution. In some examples, the walls may be coated with different acidic solids and filled with an identical acid. In certain aspects, the walls may absorb or release hydrogen ions, thus partially regulate the solution's pH. In some examples, one reservoir wall's acid may be strong. In such an example, the other reservoir wall's acid may be weak. In some examples, each reservoir has a specific hydrogen ion load (number of hydrogen ions, N_{H}). In some examples, at equilibrium, a solution's pH (or equivalently its hydronium ion activity, α_{H}) will depend on N_{H}, the reservoir's water volume, the volume and composition of the walls, as well as on other thermodynamic parameters.

In certain aspects of the materials, systems, devices, and methods as describe herein, having the partition 305 in place the reservoirs will develop their own individual equilibria. FIG. 3B is a plot of the solution pH for the two isolated reservoirs versus their total load of hydrogen ions namely, N_{H}≡(N_{H})₍ₛ₎+(N_{H})₍ₗ₎, with (N_{H})_{(s/l)}) being the number of H⁺ ions in the solid (s) and liquid (l) phases. For some examples, the pH of the liquid phase at equilibrium may be determined by thermodynamic constraint: the chemical potential of the hydrogen ions in the solid and liquid phases are equal, that is: μ₁(s)=μ₁( [symbol] ) and μ₂(s)=μ2( [symbol] ). In some examples, the reservoirs' N_{H}s may be different and thus their pHs may be different.

In some examples, as shown to the far left of FIG. 3B (N_{H}=0) no acid is present so, in such embodiments, the pHs of both reservoirs, 101 and 102, are that of pure water (pH=7.00 at 25° C.) and, as N_{H} increases, the pHs decrease in both reservoirs. In certain aspects, with sufficient N_{H}, a solution's pH can saturate, as depicted at the right of FIG. 3B. The open circle dots indicate one configuration of the cell with the two reservoirs isolated.

In certain embodiments, the partition may be removed, and the two reservoirs are coupled. Their shared walls may become a single membrane, one still consisting of the two materials but through which hydronium ions and their counter ions can thermally diffuse between the reservoirs. In such an embodiment, the system can be treated within the formalism of bipolar membranes (BPM). Further, in such an embodiment, a new equilibrium will develop, this time one for which the chemical potential of hydronium ions will be uniform throughout the entire two-reservoir cell, rather than just within individual reservoirs. In some examples, the two reservoirs settle into their joint equilibrium state. In some examples, reservoir walls coated with different acidic solids (here reverse hatch and forward hatch) are filled with an identical acid. In such embodiments, the reservoir walls are able to absorb or release hydrogen ions, thus partially regulate the solution's pH. For certain aspects, let one reservoir wall's acid be strong, the other weak. In such aspects, each reservoir has a specific hydrogen ion load (number of hydrogen ions, N_{H}). In such an aspect at equilibrium, a solution's pH (or equivalently its hydronium ion activity, aH) will depend on N_{H}, the reservoir's water volume, the volume and composition of the walls, as well as on other thermodynamic parameters. In such an embodiment, the pHs of each reservoir may maintain (solid dots) a pH difference (ΔpH=pH(2)−pH(1)).

In some examples, the partition in place the reservoirs come to their own individual equilibria. In such an embodiment, the species concentration of the liquid phase at equilibrium may be determined by thermodynamic constraint: the chemical potential of the species in the solid and liquid phases are equal, that is: μ₁(s)=μ₁(l) and μ₂(s)=μ₂(l). In certain aspects, insofar as the reservoirs' N_{H}s are different, their concentrations can also be different. In some examples, the chemical species may thermally diffuse between the reservoirs and system equilibrium may develop for which the chemical potential of species may be uniform throughout the entire two chamber cell, rather than just within individual chambers. In some examples, where the two chambers reach joint equilibrium state, the two species concentrations may remain different.

For certain aspects, consider two reservoirs 101 and 102 (FIG. 3A), separated by a thin, removable partition 305 running between them, with walls coated with different chemical solids and filled with an identical isotonic solution. In such an example, let the walls be coated with different acidic solids and filled with an identical acid. The walls are able to absorb or release hydrogen ions, thus partially regulate the solution's pH. In such an example, let one reservoir wall's acid be strong, the other weak. Further in this case, each reservoir has a specific hydrogen ion load (number of hydrogen ions, N_{H}). At equilibrium, in this case, a solution's pH (or equivalently its hydronium ion activity, aH) will depend on N_{H}, the reservoir's water volume, the volume and composition of the walls, as well as on other thermodynamic parameters. In certain aspects, with the partition in place the reservoirs will develop their own individual equilibria. FIG. 3B is a plot of the solution pH for the two isolated reservoirs versus their total load of hydrogen ions namely, N_{H}≡(N_{H})(s)+(N_{H})(l), with (N_{H})(s/l)) being the number of H⁺ ions in the solid (s) and liquid (l) phases. In such embodiments, the pH of the liquid phase at equilibrium is determined by thermodynamic constraint: the chemical potential of the hydrogen ions in the solid and liquid phases are equal, that is: μ1(s)=μ1(l) and μ2(s)=μ2(l). In certain aspects, insofar as the reservoirs' N_{H}s are different, their pHs can also be different. In some examples, at the far left of FIG. 3B (N_{H}=0) no acid is present so the pHs of both reservoirs are that of pure water (pH=7.00 at 25° C.) and, as N_{H} increases, the pHs decrease in both reservoirs. In such aspects, with sufficient N_{H}, a solution's pH can saturate, as depicted at the right of the figure. The black dots indicate one particular configuration of the cell with the two reservoirs isolated. In some examples, when the partition is removed and the two reservoirs are coupled, their shared walls become a single membrane, one still consisting of the two materials but through which hydronium ions and their counter ions can thermally diffuse between the reservoirs. In some embodiment, this system can be treated within the formalism of bipolar membranes (BPM). In certain aspects, a new equilibrium will develop, this time one for which the chemical potential of hydronium ions will be uniform throughout the entire two-reservoir cell, rather than just within individual reservoirs. As will be shown, in certain aspects, when the two reservoirs settle into their joint equilibrium state with walls coated with different acidic solids (here reverse hatch and forward hatch) and filled with an identical acid. In such an embodiment, the walls are able to absorb or release hydrogen ions, thus partially regulate the solution's pH. For certain aspects, let one reservoir wall's acid be strong, the other may be weak. Each reservoir has a specific hydrogen ion load (number of hydrogen ions, N_{H}). In such an embodiment, at equilibrium, a solution's pH (or equivalently its hydronium ion activity, aH) will depend on N_{H}, the reservoir's water volume, the volume and composition of the walls, as well as on other thermodynamic parameters, their two pHs (solid dots), may maintain a pH difference (ΔpH=pH(2)−pH(1)). In certain aspects, with the partition 305 in place the reservoirs come to their own individual equilibria. In some examples, the chemical species concentration of the liquid phase at equilibrium is determined by thermodynamic constraint: the chemical potential of the species in the solid and liquid phases are equal, that is: μ₁(s)=μ₁( [symbol] and μ₂(s)=μ₂(_ [symbol] ). In some examples, insofar as the reservoirs' N_{H}s are separated, their concentrations may maintain a difference. In some examples, the chemical species can thermally diffuse between the reservoirs. In such an example, the system equilibrium will develop for which the chemical potential of species will be uniform throughout the entire two reservoir cell, rather than just within individual reservoirs. In some examples, the two reservoirs settle into their joint equilibrium state. In such an example, two species concentrations may maintain a difference, as a concentration differential.

The crux of this new equilibrium, for certain aspects, is the membrane formed by the removal of the partition 305 (FIG. 3A). For some examples, let reservoir 1's 101 wall and membrane solids start more acidic than those of reservoir 2 102. In this case, protons may shift internally from the left side of the membrane to the right, rendering it more acidic than in its solitary state. In some examples, as indicated in FIG. 3B, the pHs of solutions 1 and 2 may shift (from open circle to solid dots). Though not required, here the shift reverses the relative pHs of the two reservoirs. In some examples, this interaction can be viewed as the weaker acid (e.g., reservoir 2 or 102) being protonated by the stronger one (reservoir 1 or 101). In some examples, just as a diprotic acid (e.g., linear perfluoropentadecane with a carboxylic acid group at one end and a sulfonic acid group at the other) can display different acidities at separate ends of the same molecule, a membrane by virtue of its construction and composition may, be more acidic on one side than on the other; thus may have different chemical activities in the same structure.

In certain aspects, membrane-solution systems may be modeled by the theory of dilute ideal solutions. In some examples, dilute solutions are ones in which solute molecules are so greatly outnumbered by solvent molecules that the former rarely interact and in ideal solutions their molecular interactions are nil (e.g., no Coulombic or Van der Waals forces). In some examples, dilute ideal solutions have much in common with ideal gases. In certain aspects, defining NS as the number of solvent molecules in a solution and N_{H} as the number of solute molecules may show that the chemical potential of the solute molecules μ_{H}, at constant temperature T and pressure P, can be written:

$${μ}_{H} ≡ {( \partial G / \partial {N}_{H} )}_{T , P , {N}_{S}} = {μ}_{o} ( T , P ) + kT ln ( {N}_{H} / {N}_{S} ) , \qquad ( 1 )$$

where μ₀(T, P) is the chemical potential under standard conditions and G is the Gibbs free energy. This can recast in terms of molality m_{H} as:

$${μ}_{H} = {μ}_{o} ( T , P ) + k T ln ( {m}_{H} ) . \qquad ( 2 )$$

In some examples, the HDD to be a solution of hydrogen ions distributed among the four regions implicit in FIG. 3A, starting from the far left: 301 solution in left reservoir; 302 left half of membrane; 303 right half of membrane; and 304 rightmost solution. In the following example, the four regions 301, 302, 303 and 304 are also referred to as (1), (2), (3) and (4), respectively. In certain aspects as before, the condition for chemical equilibrium may be μ(1)=μ(2)=μ(3)=μ(4). In some examples, the aqueous and membrane species are treated as ideal solutes. In such examples, then m_{H} will be uniform across all four regions, thus no concentration difference (Δ[H⁺]) is possible.

In some examples, there are no ideal solutions just as there are no true ideal gases. For non-ideal solutions, molality m_{H} may be replaced with activity, α≡γm_{H}. For certain aspects, the activity coefficient γ can depend on the concentration of solute molecules, temperature, surface, or membrane composition, electric or magnetic field strengths. The activity coefficient γ can depend on anything that affects the chemical behavior of the species. In some examples, aqueous species in solutions, like hydronium, are non-ideal and ions inside membranes can be even more so. Starting from the activity relation (α=γm), let us consider a simple model for the diffusion diode.

In some examples, the condition for equilibrium in the four HDD regions (301, 302, 303, 304) of FIG. 3A (μ(i−1)=μ(i)) can be written in terms of activities as α(1)=α(2)=α(3)=α(4). If the chemical species in regions 1 and 4 interact weakly and locally with their adjacent membranes, one can approximate this non-ideality with activity coefficients:

$$γ ( 1 ) = 1 - α a ( 2 ) \qquad ( 3 )$$

$$γ ( 4 ) = 1 - β a ( 3 ) , \qquad ( 4 )$$

where α and ρ are small, positive coupling constants between the aqueous species and the membranes (0≤(α≠β)<<1).

For certain aspects, equations (3,4) model a chemically active membrane. In some examples, the activity of the solute can be affected over short distances by the composition of the membrane. For certain aspects, the effects are minor yet detectable (α≠β<<1) because membrane halves are chemically different.

For some examples, suppose (m_{H}(4))/(m_{H}(1))>1 in the hydronium diode FIG. 3A. The equilibrium criterion (γ(1)m_{H}(1)=α(1)=α(4)=γ(4) m_{H}(4)) then requires γ(1)/γ(4)>1. From Equations 3 and 4 this can be expressed as (αγ(2)m_{H}(2))/(βγ(3)m_{H}(3)=(αα(2))/(βα(3))>1 which, from the equilibrium criterion (α(2)=α(3)), reduces to α/β>1. In some examples, from the original equilibrium conditions one can also show α(2)=(m_{H}(1))/(1+αm_{H}(1))<m_{H}(1) and α(3)=(m_{H}(4))/(1+m_{H}(4))<m_{H}(4). This simple model indicates that, with a suitable membrane, a non-zero ΔpH can arise, in accordance with the examples presented herein.

For certain aspects, this concentration difference Δ[H⁺] has an unexpected consequence: if the solutions are removed from the two reservoirs, then mixed (or used to drive a concentration cell) and subsequently returned to the two reservoirs, the Δ[H⁺] returns to its prior value because this is the equilibrium state of the system. For certain embodiments, this ΔpH recurrence is spontaneous and it is mediated by thermal diffusion of hydronium ions through the membrane with a net direction (from reservoir 1 101 to reservoir 2 102 FIG. 3A). For some embodiments, this system is the diffusion diode (DD).

In some examples, two reservoirs separated by a chemically-active, spatially-anisotropic membrane that is permeable to specific chemical species can establish two species concentrations at equilibrium and can be restored to that state in a thermodynamic cycle.

### Membrane

### SUMMARY

Described herein are various embodiments for a chemically asymmetrical membrane, comprising: a matrix; a plurality of binding sites, attached to, or contained within, the matrix. In some examples, the plurality of binding sites is configured to bind a chemical species, and the matrix or the plurality of binding sites form a chemical potential gradient. In some examples, the chemical potential gradient is configured to transport the chemical species in a net direction along the axis of flow via thermal diffusion as shown in FIGS. 1A-1C.

### Matrix and Membrane Materials

In some examples, the membrane is comprised of matrix and binding sites. In some examples, the matrix is a porous matrix. In some examples, the porosity is referred to as a percentage of void space. In some examples, the porous matrix comprises pores that allow for functionalization by binding sites (e.g., binding site groups) as shown in FIG. 1C, where binding sites of composition “B” are functionalized, or immobilized, onto the walls of a pore 104 of the matrix of the membrane shown in FIGS. 1A and 1B. In some examples, the matrix pores are straight. In other embodiments, the pores are not straight. In some examples, the amount that the pores are not straight and therefore do not offer a straight path of the chemical species across the membrane is referred to as tortuosity. In some examples, the pores are straight, and the internal diameter does not vary. In such examples, the internal diameter is sufficient to allow for efficient diffusion of the chemical species across the membrane along the axis of flow. FIG. 1B offers an example of a matrix with straight pores, non-varying in inner diameter. In certain embodiments, where the internal diameter is narrow enough to reduce diffusion, the pores are referred to as constricted.

In some examples, the porosity is about 0.1% to about 95%. In some examples, the porosity is about 0.1% to about 1%, about 0.1% to about 10%, about 0.1% to about 20%, about 0.1% to about 50%, about 0.1% to about 90%, about 0.1% to about 95%, about 1% to about 10%, about 1% to about 20%, about 1% to about 50%, about 1% to about 900%, about 1% to about 95%, about 10% to about 20%, about 10% to about 50%, about 10% to about 90%, about 10% to about 95%, about 20% to about 50%, about 20% to about 90%, about 20% to about 95%, about 50% to about 90%, about 50% to about 95%, or about 90% to about 95%. In some examples, the porosity is about 0.1%, about 1%, about 10%, about 20%, about 50%, about 90%, or about 95%. In some examples, the porosity is at least about 0.1%, about 1%, about 10%, about 20%, about 50%, or about 90%. In some examples, the porosity is at most about 1%, about 10%, about 20%, about 50%, about 90%, or about 95% or more.

In some examples, the pore diameter is about 10⁻⁸ m to about 10⁻⁴ m. In some examples, the pore diameter is about 10⁻⁷ m to about 10⁻⁵ m. In some examples the pore diameter is greater than 10⁻⁴ m. In some examples the pore diameter is about 10⁻⁶ m. In some examples the pore diameter is about 1 nm to about 1,000,000 nm. In some examples the pore diameter is about 10 nm to about 100,000 nm.

In some examples the membrane or matrix comprises a thickness of about 10⁻⁹ m to about 10⁻² m. In some examples the membrane or matrix comprises a thickness of about 10⁻⁸ m to about 10⁻³ m. In some examples the membrane or matrix comprises a thickness of about 10⁻⁷ m to about 10⁻⁴ m. In some examples the membrane or matrix comprises a thickness of about 10⁻⁶ m to about 10⁻⁵ m. In some examples the membrane or matrix comprises a thickness of greater than 10⁻² m.

In some examples the pore length comprises a thickness of about 10⁻⁹ m to about 10⁻² m. In some examples the pore length comprises a thickness of about 10⁻⁸ m to about 10⁻³ m. In some examples the pore length comprises a thickness of about 10⁻⁷ m to about 10⁻⁴ m. In some examples the pore length comprises a thickness of about 10⁻⁶ m to about 10⁻⁵ m. In some examples the pore length comprises a thickness of greater than 10⁻² m.

In some examples, the pore length is the same as the thickness of the membrane or matrix. In some examples, the pore length is shorter than the thickness of the membrane or matrix. In some examples, where tortuosity is high, the pore length may be longer in length than the thickness of the membrane or matrix.

In some examples, an aspect ratio is defined as the ratio of the thickness to the pore diameter. In some examples, the aspect ratio is between about 1:1 to about 1000:1 In some examples, the aspect ratio is between about 10:1 to about 100:1.

In some examples, the membrane, or the matrix comprises an organic material, an inorganic material, or a combination thereof. In some examples, the matrix comprises a polymer. In some examples, the matrix is referred to a composition of the matrix. In some examples, the matrix comprises a polymer, a crosslinked polymer, a polysulfuone, a poly-ether ether ketone, a polystyrene, a polystyrene divinylbenzene, a polyethylene, a polyethylene binder, a crosslinked gel a polystyrene, a woven polyethylene, a perfluorocarbon polymer, or a combination thereof. In some examples, the membrane comprises materials as described in Table 3 of journal article Parnamae et al., “Bipolar membranes: A review on principles, latest developments, and applications,” Journal of Membrane Science 617 (2021) 118538, the article herein incorporated by reference in its entirety.

In some examples, the membrane comprises cation exchange membranes or layers (CEM or CEL), anion exchange membranes or layers (AEM or AEL) and bipolar membranes (PM). In some examples, the membrane or the matrix comprises perfluorotetradecanoic acid (PFTDA). In some examples, the membrane or the matrix comprise a perfluorocarboxylic material.

In some examples, the perfluorocarboxylic material comprises a length of about 4 carbons to about 25 carbons. In some examples, the perfluorocarboxylic material comprises a length of about 4 carbons to about 5 carbons, about 4 carbons to about 10 carbons, about 4 carbons to about 15 carbons, about 4 carbons to about 20 carbons, about 4 carbons to about 25 carbons, about 5 carbons to about 10 carbons, about 5 carbons to about 15 carbons, about 5 carbons to about 20 carbons, about 5 carbons to about 25 carbons, about 10 carbons to about 15 carbons, about 10 carbons to about 20 carbons, about 10 carbons to about 25 carbons, about 15 carbons to about 20 carbons, about 15 carbons to about 25 carbons, or about 20 carbons to about 25 carbons. In some examples, the perfluorocarboxylic material comprises a length of about 4 carbons, about 5 carbons, about 10 carbons, about 15 carbons, about 20 carbons, or about 25 carbons. In some examples, the perfluorocarboxylic material comprises a length of at least about 4 carbons, about 5 carbons, about 10 carbons, about 15 carbons, or about 20 carbons. In some examples, the perfluorocarboxylic material comprises a length of at most about 5 carbons, about 10 carbons, about 15 carbons, about 20 carbons, or about 25 carbons.

In some examples, the matrix or the plurality of binding sites comprises a 2D material. In some examples, the 2D material is chemically functionalized differently on each side. In some examples, the matrix or the plurality of binding sites comprises two or more layers of the 2D material. In some examples, the 2D material is chemically functionalized differently either internally or on outer sides. In some examples, the 2D material graphene, stanene, and hexagonal boron nitride, molybdenum disulfide, graphyne, borophene, germanene, silicene plumbene, phosphorene, antimonene, bismuthine, metals, or a combination thereof.

In some examples, the matrix or the plurality of binding sites comprises a 3D material. In some examples, the matrix or the plurality of binding sites comprises two or more layers of the 3D material chemically functionalized differently within one or more volumes of each individual layer. In some examples, the 3D material comprises one or more members selected from the group consisting of: Nafion™, dendrimers, ionomers, organic and inorganic polymers. In some examples, the matrix or plurality of binding sites is incorporated into a concentration cell. In some examples, the matrix or the plurality of binding sites comprises one or more chemical potential gradients.

### Binding Sites

In some examples, the membrane comprises a plurality of binding sites. In some examples, at least one binding site is referred to as a functional binding group. In some embodiments at least one binding site of the plurality comprise a composition. In some examples, the composition of the at least one binding site is —N(CH₃)₃, —SO₃, —PO₃H⁻, ═NH, —NH₂, —COO⁻, —PO₃⁻, or any other binding group configured to bind to a chemical species of interest. In certain aspects, the binding site (e.g., binding site group or functional group) comprises a quaternary ammonium, sulfonic acid, bicyclic amines, or other ionic binding group. In some examples, the composition of the at least one binding site is a member selected from the group consisting of —N(CH₃)₃, —SO₃, —PO₃H⁻, ═NH, —NH₂, —COO, and —PO₃⁻. In such an embodiment, the chemical species is a solute molecule in a solution. In some examples, the solute molecule is an ion, cation, or neutral chemical species. In some examples, the solute molecule is not polar, the solute molecule may bind via van der Waals or hydrogen bonding. In some examples, where the solute molecule binds via van der Waals or hydrogen bonding, the binding site species may comprise a sugar, protein, carbohydrate.

In some examples, the matrix or the plurality of binding sites is configured to concentrate or dilute a chemical species comprising H⁺ ions, or Na+ ions, or K+ ions, Li+ ions or Cl− ions or F− or Br− or other cation or anion. In some examples, the membrane is configured to selectively diffuse ions. In some examples, the membrane is configured to selectively diffuse cations. In some examples, the membrane is configured to selectively diffuse anions. In some examples, the membrane is configured to allow for selective diffusion of the following cations comprising members from the group consisting of lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺) and ammonium ion (NH₄⁺). In some examples, the membrane is configured to allow for selective diffusion of cations comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺) or ammonium ion (NH₄⁺). In some examples, one or more membranes are configured to allow for selective diffusion of cations comprising lithium ion (Li⁺), sodium ion (Na⁺), potassium ion (K⁺), rubidium ion (Rb⁺), cesium ion (Cs⁺), magnesium ion (Mg²⁺), calcium ion (Ca²⁺), strontium ion (Sr²⁺), barium Ba²⁺, iron (II) ion (Fe²⁺), iron (III) ion (Fe³⁺), cobalt ion (Co⁺), nickel ion (Ni⁺), hydronium ion (H₃O⁺), ammonium ion (NH₄⁺), or a combination thereof. In some examples, the membrane is configured to allow for selective diffusion of the chemical species comprising ions, cations, anions, and neutral species described herein.

In some examples, the membrane is configured to allow for diffusion of ions. In some examples, the membrane is configured to allow for diffusion of cations. In some examples, the membrane is configured to allow for diffuse anions. In some examples, the membrane is configured to allow for diffusion of the following cations comprising members from the group consisting of chloride (Cl—), fluoride (F⁻), bromide (Br⁻), hydroxide (OH⁻), cyanide (CN⁻), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻) and hypochlorite (ClO⁻). In some examples, the membrane is configured to allow for diffusion of cations comprising chloride (Cl−), fluoride (F⁻), bromide (Br⁻), hydroxide (OH⁻), cyanide (CN—), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻) or hypochlorite (ClO⁻). In some examples, one or more membranes are configured to allow for diffusion of cations comprising chloride (Cl—), fluoride (F⁻), bromide (Br⁻), hydroxide (OH⁻), cyanide (CN⁻), carbonate (CaO₃²⁻), acetate (C2H₃O₂—), oxalate (C₂O₄⁻²), sulfate (SO₄²⁻), sulfite (SO₃²⁻), nitrate (NO³⁻), nitrite (NO₂⁻), phosphate (PO₄³⁻), permanganate (MnO₄⁻), chromate (CrO₄⁻²), dichromate (Cr₂O₇⁻²), perchlorate (ClO₄⁻), chlorate (ClO₃⁻), chlorite (ClO₂⁻), hypochlorite (ClO⁻) or a combination thereof. In some examples, the membrane is configured to allow for selective diffusion of the chemical species comprising ions, cations, anions, and neutral species described herein.

In some examples, the binding site is configured to bind the chemical species for a period of time. In some examples, the binding time is referred to as a residence time. In some examples, the residence time is between about 10⁻¹¹ s to greater than about 1000 s. In some examples, the residence time is between about 10⁻¹⁰ s to greater than about 100 s. In some examples, the residence time is between about 10⁻⁹ s to greater than about 10 s. In some examples, the residence time is between about 10⁻⁸ s to greater than about 1 s. In some examples, the residence time is between about 10⁻⁷ s to greater than about 10⁻¹ s. In some examples, the residence time is between about 10⁻⁶ s to greater than about 10⁻² s. In some examples, residence time is between about a 10⁻⁵ s to about 10⁻³ s.

In some examples, a maximum binding site number density is between about 10¹² per m² to about 10¹⁹ per m². In some examples, a maximum binding site number density is between about 10¹³ per m² to about 10¹⁹ per m². In some examples, a maximum binding site number density is between about 10¹⁴ per m² to about 10¹⁹ per m². In some examples, a maximum binding site number density is between about 10¹⁵ per m² to about 10¹⁹ per m². In some examples, a maximum binding site number density is between about 10¹⁶ per m² to about 10¹⁹ per m². In some examples, a maximum binding site number density is between about 10¹⁷ per m² to about 10¹⁹ per m². In some examples, a maximum binding site number density is greater than 10¹⁹ per m². In some examples, the maximum binding site number density is about 10¹⁸ per m².

In some examples, a binding site exhibits a binding site free energy value. In some examples, the free energy value is dependent in part of the composition of the binding site. In some examples, the free energy value of each binding site of the plurality depends, in part, from a composition of each binding site of the plurality. In some examples, the binding site free energy value is between about 1/100 eV to about 20 eV. In some examples, the binding site free energy value is between about 1/50 eV to about 10 eV. In some examples, the binding site free energy value is between about 1/10 eV to about 1 eV. In some examples, the binding site free energy value is about 1 eV.

### Chemical Potential Gradient

In some examples, the matrix and the plurality of binding sites are configured to provide a chemical potential gradient. In some examples, the matrix and the plurality of binding sites are arranged to provide a chemical potential gradient. In some examples, the matrix, the plurality of the binding sites, and a free energy value of each binding site of the plurality forms a chemical potential gradient. In some examples, the chemical potential is non-zero, and varies in a linear, exponential, sigmoidal, stepwise, or polynomial fashion, or a combination thereof along the axis of flow. In some examples, a number density of binding sites (e.g., concentration or [B]) varies along the axis of flow of the membrane as shown in FIG. 1C. In some examples, the composition of each binding site of the plurality of binding sites varies along the axis of flow of the membrane. In some examples, the chemical potential gradient is the composite of the binding site free energy of each binding site located along the axis of flow. In some examples, the chemical potential is non-zero, and varies in a linear, exponential, sigmoidal, stepwise, or polynomial fashion, or a combination thereof along the axis of flow. In some examples, the chemical potential gradient of B, induces a concentration gradient of chemical species, [A], that corresponds to the number density gradient, or concentration gradient of chemical species B, as shown in FIG. 1C. In some examples, as the number density of B (concentration of B, [B]) increases along the axis of flow of the membrane, the concentration of chemical species A decreases along the axis of flow of the membrane as shown in FIG. 1C. In some examples, as the number density of B (e.g., concentration of B or [B]) increases along the axis of flow of the membrane, the concentration of chemical species A decreases along the axis of flow of the membrane resulting in a net flow of chemical species A in the opposite direction of the increasing number density of B (e.g., concentration of B or [B]), as shown in FIG. 1C. In some examples, as the number density of B (e.g., concentration of B or [B]) increases along the axis of flow of the membrane, the concentration of chemical species A decreases along the axis of flow of the membrane resulting in a net flow of chemical species A in the opposite direction of the increasing number density of B (e.g., concentration of B or [B]), as shown in FIG. 1C, the net flow of chemical species A is driven by ambient thermal energy.

### Thermally Driven Net Flow of Chemical Species and Applications

In some examples, the chemical potential gradient is configured to transport the chemical species in a net direction along the axis of flow via thermal diffusion driven by ambient thermal energy, ambient temperature of the surroundings, or a combination thereof. In some examples, the ambient temperature is between about the melting point and about the boiling point of a solvent of a solution that solvates the solute. In some examples, the ambient temperature is between the melting point and boiling point of a solvent of a solution that solvates the solute, where the solute is chemical species A.

In some examples the solvent of the solution that solvates the solute comprises water. In some examples the solution comprises an aqueous solution. In some examples the solvent comprises an organic solvent. In some examples, the solvent comprises a mixture of aqueous and organic solvents. In some examples, the organic solvent comprises a polar organic solvent. In some examples, the organic solvent comprises a non-polar organic solvent. In some examples, the organic solvent comprises a polar a-protic organic solvent. In some examples, the organic solvent comprises a polar protic solvent. In some examples the solvent comprises water, an alcohol, an aldehyde, a ketone, an alkane, alkyne. In some examples, the solvent may comprise water. In some embodiments, the solvent is water. In some examples, the solvent may comprise water, methanol, ethanol, iso-propanol, n-propanol, n-butanol, pentane, hexane, cyclohexane, heptane, benzene, toluene, xylene, acetone, chloroform, carbon tetrachloride, diethyl ether, dimethyl ether, ethylmethyl ether, ethyl acetate, methyl acetate, dimethylsulfoxide (DMSO), tetrahydrofuran (THF), methylethyl ketone, dimethylformamide (DMF), dichloromethane, petroleum ether, kerosene, pyridine, methyl chloride, acetic acid, formic acid, ammonia, ammonium hydroxide, hydrochloric acid (HCl), sulfuric acid, nitric acid, sodium hydroxide (NaOH), or a combination thereof. In some examples, the membrane, device, system, or method does not comprise a solvent. In some examples, the membrane, device, system, or method does not comprise a solvent, and the membrane is located between two reservoirs 101 and 102 (as shown in FIG. 1A) comprising solids that allow for migration of the chemical species from the first reservoir 101 to the second reservoir 102 thermally driven through the membrane by ambient thermal energy.

In some examples, the matrix or the plurality of binding sites is configured to generate a concentration differential of one or more chemical species. In some examples, the matrix or the plurality of binding sites is configured to create one or more concentration differentials of one or more chemical species present in one or more or more solutions. In some examples, at least one solution of the one or more solutions is liquid phase, solid phase, gas phase, or a combination thereof. In some examples, the one or more solutions are aqueous, non-aqueous or a combination thereof. In some examples, the matrix or the plurality of binding sites is configured to concentrate or dilute a chemical species. In some examples, the matrix or the plurality of binding sites is configured to concentrate one or more electrically neutral chemical species in the one or more solution. In some examples, the one or more electrically neutral chemical species comprises: a sugar, a protein, a carbohydrate, a fat, or an amino acid. In some examples, the matrix or the plurality of binding sites may be configured to desalinate water. In some embodiments, the matrix or the plurality of binding sites comprises one or more planar sub-membranes. In some examples, the matrix or the plurality of binding sites comprises one or more cylindrical sub-membranes.

In some examples, a system comprises at least one additional membrane. In some examples, the at least one additional membrane is arranged in series with the membrane. In some examples, a system comprises at least one additional membrane is arranged in parallel with the membrane. In some examples, a system comprises at least one additional membrane comprises at least one membrane. In some examples, the at least two membranes are arranged in series, in parallel, or in a combination thereof. In some examples, a system comprises the membrane arranged in between a first reservoir of one or more reservoirs and a second reservoir of the one or more reservoirs. In some examples, a system comprises the membrane is arranged in between the first reservoir of the one or more reservoirs and the second reservoir of the one or more reservoirs. In some examples, the at least one additional membrane is arranged between the second reservoir and a third reservoir of the one or more reservoirs.

In some examples, the membrane is configured as an ion exchange membrane. In some examples, the membrane is configured as a cation exchange membrane, an anion exchange membrane, or a combination of both.

In some examples, the membrane is configured as a cation exchange layer, an anion exchange layer, or a combination of both. In some examples, the cation exchange layer (CEL) comprises N-methylene phosphonic chitosan 150 μm, SPPO, Neosepta CM-I (150 μm), SPS (100 μm), SPEEK/PES (130 11 m), HPAN (100 μm), PES (150 μm), S-PEEK/PES (80 μm), PVA-SA (28 μm), PVA-SA (55 μm), PVA-SA (45 μm), CMC-PVA (59 um), SPES (20 μm), CMC-PVA, Nafion (30 μm), sulfonated PS (100 μm), or a combination thereof. In some examples, the anion exchange layer comprises quaternized chitosan (150 um), QN3362BW (200 μm), GMA-DVB-Py (10 um), QPPO, QA/336ZBW (420 um), QPS (100 um), Fumatech FAA3 (80-100 μm), chloromethylated and aminated PS (150 μm), A-Psf (Fumatech) (10 um), Sustainion X37-S0 (SO μm), Aminated PECH-PVDF (20 um), perfluorinated alkylammonium (PFAEM, 30 um), Neosepta AHA (Tokuyama) (220 um), aminated PPO (114 μm), quaternized PS (100 μm). In some examples, the membrane comprises a WD catalyst layer comprising Neosepta BP-1, FumaSep FBM, or AQ-6. In some examples, the membrane comprises any at least one of any material listed in Table 1 of Giesbrecht et al., “Recent Advances in Bipolar Membrane Design and Applications,” Chem. Mater. 2020, 32, 8060-8090, the article herein incorporated by reference in its entirety.

In some examples, a membrane comprises one or more layers. In some examples, each a layer of the one or more layers comprises one or more chemical potential gradients. In some examples each layer may comprise a layer with different chemical and diffusive characteristics. In some examples, each layer in a membrane with two layers may be referred to as a membrane half.

### Thermally Driven Diffusion Diode Devices

### Summary

In some examples, a thermally driven diffusion diode device comprises a membrane. In some examples, comprises a membrane with two layers. In some examples comprising a two-layer membrane, each layer comprises different chemical and diffusive characteristics in either membrane half. In some examples, a two-layer membrane, where each layer comprises different chemical and diffusive characteristics, is referred to as a bipolar membrane. In some examples, the membrane separates two physically different and separated liquid, semi-liquid, or solid reservoirs containing an ionic or neutral species that is diffusion-active with respect to the membrane. In certain embodiments, for ionic concentration separations bipolar membranes may be used. Thermal-chemical diffusion of the reservoirs' active species establishes a concentration difference between the two reservoirs which, in turn, possess physical chemical energy and may be used to drive a thermally driven diffusion diode-based device, in accordance with some embodiments. In some examples, the thermally driven diffusion diode device is configured to perform separation, concentration, or dilution of a chemical species. In some examples, the thermally driven diffusion diode device is configured as a battery, the battery comprising electrodes. The electrodes for the thermally driven diffusion diode battery may be in contact with, in fluid contact with, in electrical contact with, incorporated into, or located in reservoirs of the device. In some examples, the thermally driven diffusion device may be micron-sized or room-sized (e.g., 10 meters in at least one dimension). In some examples, the thermally driven diffusion device can be combined in series or parallel configurations to increase the total current or voltage outputs of the combined system according to the rules of electronics and batteries.

### Thermally Driven Diffusion Diode

Described herein are various examples of a thermally driven diffusion diode devices, systems, and methods. FIGS. 1A-1C show a non-limiting schematic of a thermally driven diffusion diode device. FIG. 1A shows a thermally driven diffusion diode comprising a chemically asymmetric membrane (CAM) (e.g., membrane) located between at least two reservoirs in accordance with some embodiments. In some examples, as shown in FIG. 1A a thermally driven diffusion diode comprises one membrane 103 located between a first 101 and a second reservoir 102. FIG. 1B shows a non-limiting cross-section of the CAM. FIG. 1C shows a cross section of a pore within the CAM, where binding sites, B, form a gradient of increasing number density from left to right, in accordance with some embodiments.

Various examples of a thermally driven diffusion diode device comprising: one or more reservoirs comprising: a first reservoir (e.g., 101 of FIG. 1A) configured to receive a first solution comprising a chemical species (e.g., A of FIG. 1A); a second reservoir (e.g., 102 of FIG. 1A) comprising a second solution configured to receive the chemical species; one or more membranes (e.g., 103 of FIG. 1A), at least one membrane of the one or more membranes comprises a chemical potential gradient. In some examples, the chemical potential gradient is non-zero along an axis of flow of the membrane. In some examples, the membrane is located between and in contact with at least the first and second reservoir, and the matrix or plurality of binding sites is configured to transport the chemical species in a net direction along the axis of flow via thermal diffusion. In some examples, the device further comprises a differential concentration. In some examples, the first reservoir comprises the chemical species at a first concentration value and the second reservoir comprises the chemical species at a second concentration value. In some examples, the first concentration value is not equal to the second concentration value. In some examples, the one or more membranes are configured generate the equilibrium state via thermally driven diffusion of the chemical species. In some examples, the chemical species comprises an ion. In some examples, the device further comprises a counter ion. In some examples, the device does not comprise a salt bridge. In some examples, the binding sites are configured to bind with the counter ion. In some examples, the binding sites are configured to bind to the counter ion and transport both counter ion and the ion.

Thermally driven diffusion diode devices, comprising at least one membrane and at least two reservoirs may be micron-sized. Thermally driven diffusion diode devices, comprising at least one membrane and at least two reservoirs may be room-sized (e.g., 10 meters in at least one dimension).

Thermally driven diffusion diode devices, comprising at least one membrane and at least two reservoirs may be combined in series or parallel configurations. In some examples, at least one additional membrane is arranged in series with the membrane. In some examples, the at least one additional membrane is arranged in parallel with the membrane. In some examples, the at least one additional membrane comprises at least two membranes. In some examples, the at least two membranes are arranged in series, in parallel, or in a combination thereof. In some examples, the at least one additional membrane is arranged between the second reservoir and at least a third reservoir of the one or more reservoirs.

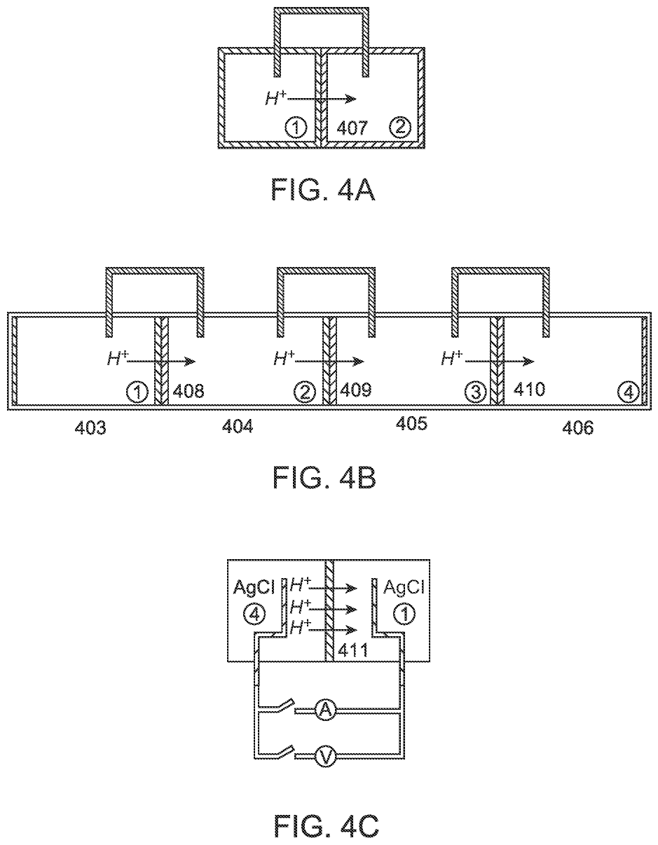

In some examples, as shown in FIG. 4A, a thermally driven diffusion diode comprises a first reservoir 101, a membrane 407 and a second reservoir 102. In some examples, as shown in FIG. 4B, a thermally driven diffusion diode comprises four reservoirs and three membranes, arranged in series in the following order from left to right: a first reservoir 403, a first membrane 408, a second reservoir 404, a second membrane 409, a third reservoir 405, a third membrane 410 and a third reservoir 406.

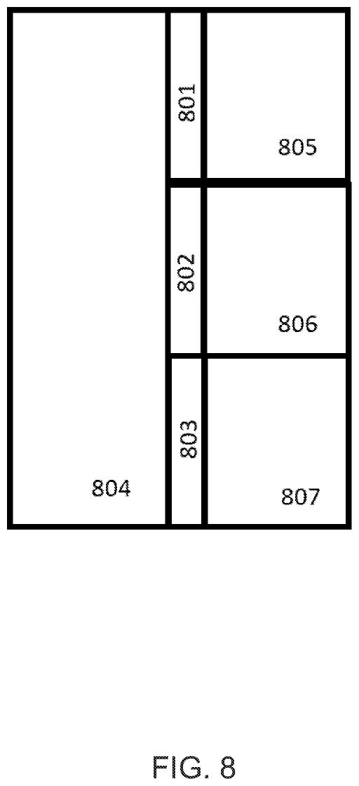

In some examples, a thermally driven diffusion diode can be arranged in parallel. In some examples, a thermally driven diffusion diode can be arranged in parallel for separating a mixture into its components. In some examples, as shown in FIG. 4B, reservoirs and membranes may be arranged in series for concentrating a chemical species. In another example, the parallel device as shown in FIG. 8 may consists of a reservoir 804 for receiving a solution mixture, three chemically asymmetric membranes (CAM) 801-803, where each membrane separately contacts an isolated reservoir 805-807. In such an example, a receiving reservoir 804 may receive a solution mixture. In some examples, the solution mixture may comprise a plurality of different chemical species. In such an example, thermally driven diffusion diode may comprise a plurality of CAMs. In such an example, each of the plurality of CAMs is configured to selectively diffuse each of the plurality of different chemical species in the mixture. In some examples, the solution may contain three different chemical species, A, B, C. In some examples, the thermally driven diffusion diode may comprise three different CAMs each configured to selectively allow diffusion of each different chemical species. In such an example, as shown in FIG. 8, CAM 801 is configured to separate species A, one CAM 802 is configured to separate species B, and one CAM 803 is configured to separate species C, from the mixture containing all chemical species A, B, and C. In some examples, when the parallel configured thermally driven diffusion diode is exposed to an ambient temperature a net flow of species A, B and C is set up, flowing through CAMS 801-803 into reservoirs 805-807, and occurs until chemical equilibrium is reached. At chemical equilibrium the concentration of species A, B, and C is greater in reservoirs 805-807, respectively, as compared to each of the original concentrations of chemical species A, B, and C, respectively, as received in reservoir 804.

In some examples, the thermally driven diffusion diode devices may be configured as, and referred to as, a concentration cell, a dilution cell, or a combination thereof.

Thermally driven diffusion diode devices may be configured to separate at least one chemical species from a solution mixture comprising at least one chemical species. In some examples, a thermally driven diffusion device configured to separate at least one chemical species from a solution mixture may comprise a concentration cell. In some examples, a thermally driven diffusion device configured to separate at least one chemical species from a solution mixture may comprise a dilution cell in accordance with some embodiments.

Described herein are various examples of a desalination device. In some examples, the desalination device comprises a chemically asymmetric membrane as described herein. In some examples, a desalination device, or system, comprises a thermal diffusion diode device as described herein. In some examples, a thermally driven diffusion device as described herein is configured for use as a desalination device. Thermally driven diffusion diode devices configured as desalination devices comprise a membrane configured for selective diffusion of ions known to be present in seawater. Thermally driven diffusion diode devices configured as desalination devices may comprise one or more membranes each configured to selectively diffuse ions including chloride (Cl⁻), sodium (Na⁺), sulfate (SO₄²⁻), magnesium (Mg²⁺), calcium (Ca²⁺), potassium (K⁺), or a combination thereof. In some examples, a thermally driven diffusion device configured as desalination device may comprise concentration and/or dilution cells in series, in parallel, or a combination thereof, in accordance with some embodiments.

Compositions, devices, systems, and methods as described in this section can include an example, variation or embodiment of a membrane, such as any membrane for example as described in the membrane section of this application.

### Thermal Diffusion Diode Battery

Described herein are various embodiments of a thermally driven diffusion diode battery device, comprising: one or more reservoirs comprising: a first reservoir configured to receive a first solution comprising a chemical species; a second reservoir comprising a second solution configured to receive the chemical species; one or more membranes. In some examples, at least one membrane of the one or more membranes comprises a chemical potential gradient. In some examples, the chemical potential gradient is non-zero along an axis of flow of the membrane. In some examples, the one or more membranes is located between and in contact with at least the first and second reservoir. In some examples, the matrix or plurality of binding sites is configured to transport the chemical species in a net direction along the axis of flow via thermal diffusion; and a first electrode in contact with the first reservoir and a second electrode in contact with the second reservoir; and wherein the first and second electrode are configured to exhibit an electrical potential difference upon transport the chemical species in a net direction along the axis of flow via thermal diffusion. In some examples, the device comprises an equilibrium state. In some examples, the first reservoir comprises the ion at a first concentration value and the second reservoir comprises the ion at a second concentration value. In some examples, the first concentration value is not equal to the second concentration value. In some examples, the one or more membranes are configured generate the equilibrium state via thermally driven diffusion of the ion. In some examples, the thermal energy is ambient thermal energy. In some examples, the first electrode is located in the first reservoir and the second electrode is located in the second reservoir. In some examples, the chemical species comprises an ion, a counter ion, or a combination thereof. In some examples, the plurality of binding sites is configured to bind the ion. In some examples, the chemical species is the counter ion of the ion. In some examples, the device does not comprise a salt bridge. In some examples, at least one additional membrane is arranged in series with the membrane. In some examples, the at least one additional membrane is arranged in parallel with the membrane. In some examples, the at least one additional membrane comprises at least two membranes. In some examples, the at least two membranes are arranged in series, in parallel, or in a combination thereof. In some examples, the at least one additional membrane is arranged between the second reservoir and at least a third reservoir of the one or more reservoirs.

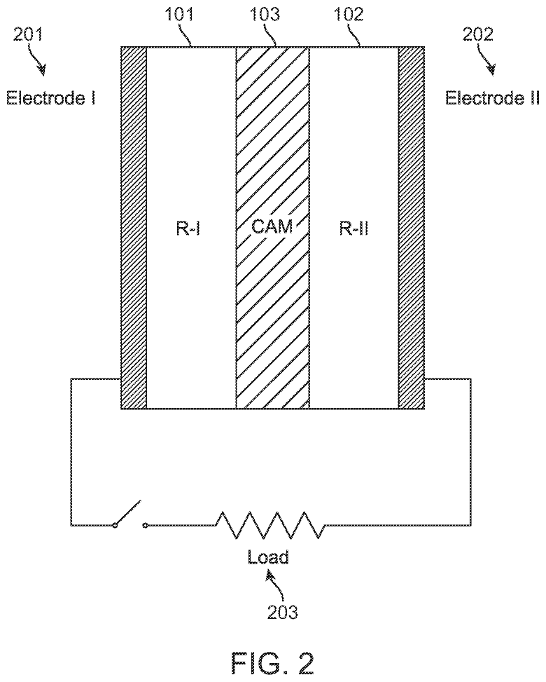

FIG. 2 shows a non-limiting schematic for a device comprising a chemically asymmetric membrane configured as a thermal diffusion driven battery, as described herein. A CAM 103, a first 101 and second reservoir 102 are shown in addition to a first 201 and second electrode 202. In some examples, the first electrode 201 is in contact with the first reservoir 101 and the second electrode is in contact with the second reservoir 202. An electrical load 203 is connected across the first 201 and second electrode 202. An electrical switch 204 is also shown.

Thermally driven diffusion diode devices, comprising at least one membrane and at least two reservoirs may be combined in series. Thermally driven diffusion diode devices, comprising at least one membrane and at least two reservoirs may be combined in parallel. Thermally driven diffusion diode devices, comprising at least one membrane and at least two reservoirs may be combined in parallel or series configurations to increase the total current or voltage outputs of the combined system according to the standard rules of electronics and batteries.

In some embodiments, a thermally driven diffusion diode battery may comprise a membrane selective for hydronium ion and may be referred to as a hydronium diffusion diode (HDD). In some examples, a hydronium diffusion diode HDD cell is referred to as an electrochemical concentration cell (FIGS. 3A and 3B and FIGS. 4A-4C). FIG. 3A shows a non-limiting schematic of a thermal diffusion diode cell (e.g., concentration cell) configured to transport hydronium ion, as described herein. Reservoirs containing solid or liquid solutions are separated by a diffusion diode membrane. A salt bridge connecting reservoirs to balance electrostatic potential. Neutral or ionic chemical species preferentially thermally diffuse from one reservoir to the other. Partition runs between the reservoirs 101 and 103. FIG. 4C shows an example of an HDD cell comprising AgCl—Ag electrodes connected to an electrical circuit. In some examples, upon exposure to ambient thermal energy the thermal diffusion diode battery produces an electrical potential difference across the electrodes. In some examples, the thermal diffusion diode battery maintains the electrical potential at thermal equilibrium.

In some examples, HDD and ion diffusion diode (IDD) membranes are applicable to other electrochemical systems. In some examples, thermally driven diffusion diodes may improve existing batteries or for the development of other types of ion battery (e.g., Li⁻, Mg⁻, Na⁻, K⁻, or Ca²⁺ based), In some examples, thermally driven diffusion diodes may be used for the separation and concentration of chemical species, e.g., desalination or isolation of metal ions from complex fluids. In some examples, thermally driven diffusion diodes may be used for Nafion-based applications. In some examples, the operational characteristics of the HDD battery (e.g., current, emf, power density, recharging time) may be improved by several orders of magnitude by making relatively simple modifications. In some examples, the output current and power may be boosted by increasing the cell's hydronium ion concentration (lowering pH), optimizing the Nafion-PFTDA blend, and by increasing the AgCl electrode surface area, for instance, by replacing the present planar electrode with silver foam. In some examples, the length of the HDD cell (L) can be reduced by 1-2 orders of magnitude, thereby reducing the recharging time of the cell (τᵣ) from hours to minutes. In some examples, τᵣ is diffusion limited, and because a system's diffusion time (τ_{d}) dimensionally scales with its diffusion coefficient (D) and system length scale (L) as T_{d}˜L²/D, modest reductions in L may yield significant reductions in τᵣ. In some examples, higher order series cell arrangements—longer than the (N=3)-membrane cell in FIG. 4B—may produce larger ΔpHs and resultant emfs. At least two series configurations can be imagined. In some examples, long chain of multi-membrane HDD cells—longer versions of FIG. 4C, its ΔpH (hence emf) may increase logarithmically, scaling like the Nernst relation, Eq. (1); that is, emf˜1n(N). In contrast, in some examples comprising a single-membrane HDD cell with small ΔpH, the ΔpH˜1n(1+ΔpH)˜ΔpH. In some examples, where N (e.g., number of) ΔpHs are translated into N individual batteries arranged in series, their total emf may scale linearly, that is, emf˜N. In some examples, N>>1n(N) for N>>1. In some examples, the ion diffusion diode (IDD) membrane may be constructed from suitably functionalized 2D materials, like graphene, stanene, hexagonal boron nitride (HBN), molybdenum disulfide, or one of the other roughly 700 “-ene,” “-ane,” and “-ide” single-layer materials predicted to be stable. In some examples, with sufficiently thin cells, aqueous solutions might be profitably replaced with (semi-) solid electrolytes, thereby boosting energy and power densities while not unduly compromising diffusive charging. In some examples, commercial bipolar membranes (e.g., Fumasep FBM) may be used, which may result in greater ΔV's and ΔpH's (larger by a factor of ten or more for single-membrane systems). In some examples, agar-electrolyte salt bridges, which normally extend outside the HDD, may be replaced by small anion exchange membrane discs (e.g., Fumasep FAB-PK-130) built directly into the main membrane. In some examples, AgCl—Ag electrodes may be incorporated into the reservoirs so as to create an integrated concentration cell. In such examples, size and cost of the devices may be improved, while improving their scalability.

Compositions, devices, systems, and methods as described in this section can include an example, variation or embodiment of a membrane, such as any membrane for example as described in the membrane section of this application. Additionally, compositions, devices, systems, and methods as described in this section can include an example, variation or embodiment of a thermally driven diffusion diode, such as any thermally driven diffusion diode for example as described in the thermally driven diffusion diode section of this application.

### Methods

### Method of Using a Thermal Diffusion Diode

Described herein are various examples of a method for using a thermally driven diffusion diode, comprising: obtaining a thermally driven diffusion diode comprising a first and second reservoir of two or more reservoirs and a membrane of one or more membranes. In some examples, the membrane is in between the first and second reservoir. In some examples, the membrane comprises a matrix or plurality of binding sites that are configured to transport a chemical species in a net direction along an axis of flow via thermal diffusion; obtaining a solution comprising a first concentration of the chemical species of at least one chemical species; allowing movement of the chemical species across the membrane to the second reservoir. In some examples, the movement of the chemical species is thermally driven toward an equilibrium state. In some examples, the chemical species, located in the second reservoir comprises a second concentration value, and wherein the first concentration value is not equal to the second concentration value.

Described herein are various methods for using a thermally driven diffusion diode for concentrating hydronium ions. In some examples, the method comprises using a thermally driven diffusion diode for diluting hydronium ions. In some examples, the method further comprises: obtaining a device (e.g., device as shown in FIGS. 4A), comprising: a first reservoir (1) configured to receive a high pH solution (e.g. basic or neutral), a membrane 407 configured for the selective diffusion of a hydronium ion, and a second reservoir (2) to receive the hydronium ion from the membrane. In some examples, the membrane 407 is located between the first reservoir (1) and the second reservoir (2). In some examples, the method further comprises connecting the first reservoir (1) to a supply of high pH solution. In some examples, the method further comprises exposing the device to ambient thermal energy. In some examples, the method further comprises allowing thermally driven diffusion of the hydronium ions from the first reservoir containing the high pH solution, through the membranes 407, and into the second reservoir (2). In some examples, the method further comprises collecting a low pH solution from the second reservoir, where the hydronium ions present in the low pH solution originated from the high pH solution.

Described herein are various methods for using a thermally driven diffusion diode for desalination of water. In some examples, the method further comprises: obtaining a device comprising: a first reservoir for receiving salt water, a plurality of membranes configured to selectively diffuse a plurality of ions, the plurality comprising: a chloride (Cl⁻) ion, sodium (Na⁺) ion, a sulfate (SO₄²⁻) ion, a magnesium (Mg²⁺) ion, a calcium (Ca²⁺) ion, a potassium (K⁺) ion, or a combination thereof, and at least one concentrate reservoir arranged to receiving the an ion of the plurality of ions through a membrane of the plurality of membranes. In some examples, the plurality of membranes and plurality of concentrate reservoirs are arranged in a parallel as shown in FIG. 8. In some examples, the method further comprising filling the first reservoir with water containing at least one ion of the plurality of ions. In some examples, the method further comprises exposing the device to thermal ambient energy. In some examples, the method further comprises allowing the thermally driven diffusion of the plurality of ions from the first reservoir containing the salt water, through the plurality of membranes, and into the at least one concentrate reservoir. In some examples, the method further comprises collecting the salt water, where the salt water upon the collecting is lower in concentration of the plurality of ions than before the filling of the reservoir with the salt water. In some examples, the salt water, upon the collecting is referred to as fresh water.

Compositions, devices, systems, and methods as described in this section can include an example, variation or embodiment of a membrane, thermally driven diffusion diode, or thermally driven diffusion diode battery such as any membrane, thermally driven diffusion diode, or thermally driven diffusion diode battery for example as described in the membrane, thermally driven diffusion diode, or battery sections of this application.

### Method of Using a Thermal Diffusion Diode Battery

Described herein are various methods for using a thermal diffusion diode battery device, comprising: obtaining a thermal diffusion diode battery comprising a first and second reservoir of two or more reservoirs and a membrane of one or more membranes. In some examples, the membrane is in between the first and second reservoir, and wherein the membrane comprises a matrix or plurality of binding sites that are configured to transport a chemical species in a net direction along an axis of flow via thermal diffusion; obtaining a solution comprising a first concentration of the chemical species of at least one chemical species; allowing movement of the chemical species across the membrane to the second reservoir, and wherein the movement of the chemical species is thermally driven toward an equilibrium state. In some examples, the chemical species, located in the second reservoir comprises a second concentration value, and wherein the first concentration value is not equal to the second concentration value; allowing a first electrode in contact with the first reservoir and a second electrode in contact with the second reservoir to exhibit an electrical potential difference upon transport the chemical species in a net direction along the axis of flow via thermal diffusion. In some examples, the first and second electrodes are located in the first and second reservoir, respectively. In some examples, the thermal diffusion diode battery is connected to a load. In some examples, the method further comprises allowing the user to utilize the electrical potential difference to operate the load.

Described herein are various methods for using a thermal diffusion diode battery device and/or system for generating, using, and storing electrical power. In some examples, the method further comprising obtaining a thermally driven hydronium ion diffusion diode (HDD) battery device. In some examples, the thermally driven hydronium ion diffusion diode (HDD) battery device comprises a membrane configured for membrane configured for selective diffusion of hydronium ion and electrodes comprising silver chloride as shown in FIG. 4C. In some examples, thermally driven hydronium ion diffusion diode (HDD) battery device comprises an acidic solution comprising hydronium ions. In some examples, the acidic solution is equal in pH in both the first 101 and second reservoir 102. In some examples, the method further comprises exposing the thermally driven hydronium ion diffusion diode (HDD) battery device to ambient thermal energy. In some examples, the method further comprises allowing thermally driven diffusion of the hydronium ions from the first reservoir containing the low pH solution, through the membranes 103, and into the second reservoir (2). In some examples, the method further comprises allowing an electrical potential difference to develop across the electrodes (FIG. 4C). In some examples, the thermal diffusion diode battery is connected to a load. In some examples, the method further comprises allowing the user to utilize the electrical potential difference to operate the load.

Compositions, devices, systems, and methods as described in this section can include an example, variation or embodiment of a membrane, thermally driven diffusion diode, or battery such as any membrane, thermally driven diffusion diode, or battery for example as described in the membrane, thermally driven diffusion diode, or battery sections of this application.

### Numbered Embodiments

1. In some examples, the membrane will be used to create concentration differentials of one specific chemical or ionic species between two isolated solutions (liquid or semi-solid).

2. In some examples, the membrane will be used to create multiple concentration differentials of specific chemical or ionic species between two isolated solutions (liquid or semi-solid).

3. In some examples, multiple membranes arranged in series will be used to create one or more enhanced concentration differentials of specific chemical or ionic species between two or more isolated solutions reservoirs (liquid or semi-solid).

4. In some examples, the membrane will act between aqueous (water-based) solutions to achieve concentration differences between the two or more solutions.

5. In some examples, the membrane will act between non-aqueous (non-water-based) solutions to achieve concentration differences between the two or more solutions.

6. In some examples, the membrane will act between aqueous or non-aqueous semi-solid solutions to achieve concentration differences between the two or more semi-solid solutions.

7. In some examples, one or more membranes will act between aqueous or non-aqueous liquid or semi-solid solutions to achieve concentration differences between the two or more semi-solid solutions with the addition of metallic or non-metallic electrodes in the solution reservoirs, arranged to fashion an electro chemical concentration cell.

8. In some examples, the one or more membranes will be used to concentrate H+ ions, or Na+ ions, or K+ ions, Li+ ions or Cl− ions or F− or Br− or other cation or anion in one solution relative to another solution across the active membrane.

9. In some examples, the one or more membranes will be used to concentrate one or more electrically neutral chemical species (e.g., sugars, proteins, carbohydrates, fats, amino acids) in one solution relative to another solution across the active membrane.

10. In some examples, the one or more membranes will be used to desalinate water.

11. In some examples, the membrane will consist of two or more planar sub-membranes.

12. In some examples, the membrane will consist of two or more cylindrical sub-membranes.

13. In some examples, the membrane will consist of a 2D material (e.g., graphene, stanene, hexagonal boron nitride) chemically functionalized differently on each side.

14. In some examples, the membrane will consist of two or more layers of 2D material (e.g., graphene, stanene, hexagonal boron nitride) chemically functionalized differently either internally or on their outer sides.

15. In some examples, the membrane will consist of two or more layers of 3D material (e.g., Nafion, dendrimers, ionomers, organic and inorganic polymers) chemically functionalized differently within the volumes of each individual layer.

16. In some examples, the membrane will be incorporated in hydrogen fuel cells.

18. In some examples, the membrane will be incorporated into a chemical concentration cell.

19. In some examples, the membrane between solutions will consist of two or more layers of commercially available bipolar membranes (e.g., Fumasep BPM, Xion BPM).

### EXAMPLES

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Example 1: Hydronium Diffusion Diode Cell and Battery

In this section an experimental example of a hydronium diffusion diode HDD cell is described (FIGS. 3A-3B and FIGS. 4A-4C). FIG. 3A shows a non-limiting schematic of a thermal diffusion diode cell (e.g., concentration cell) configured to transport hydronium ion, as described herein. In this example, the device is referred to as a hydronium diffusion diode (HDD). Reservoirs were separated by a diffusion diode membrane. A salt bridge connected reservoirs to balance electrostatic potential. Neutral or ionic chemical species preferentially thermally diffuse from one reservoir to the other. Partition 305 runs between the reservoirs 101 and 103. FIG. 3B. Solution pH versus total hydrogen ion load (N_{H}) in reservoirs 1 and 2. Open circle dots: membrane partition in place. Solid dots: partition 305 removed. The central pieces of apparatus for these experiments were the three membrane-based items shown in FIGS. 4A-4C, as well as standard supporting hardware for electrochemistry: a) pH meter (Hanna model HI-2221, resolution ΔpH=0.01); b) picoammeter (Keithley model 487); c) nanovoltmeter (Keithley model 2182); and d) spin coater (Instras model STV3S). The primary piece of apparatus was the single-membrane HDD (FIG. 4A), consisting of two teflon-o-ring-sealed, cylindrical reservoirs (O.D.=3.2 cm, I.D.=1.9 cm, Length=5 cm), custom machined from pure teflon. Teflon (polytetrafluoroethylene (PTFE), DuPont) was chosen for its chemical inertness, impermeability to liquids, and machinability. Between the two reservoirs was clamped a circular HDD membrane (25 mm diameter, 25 microns thick) mounted between two teflon washers (thickness=0.15 cm, O.D.=3.8 cm, I.D.=1.9 cm) that exposed the central 1.9 cm diameter of the membrane to the reservoir solutions, while separating them. The interior walls of each reservoir were lined with a thin layer of the same chemical blend as the membrane surface adjacent to it; in FIG. 4A, the left (back-slash hash) walls and half-membrane correspond to pure (100%) Nafion 1100 (designated 100-0), while the right (forward-slash hash) walls and half-membrane were 33% Nafion and 67% perfluorotetrade-canoic acid (PFTDA), designated 33-67. Nafion is a perfluorocarbon superacid ionomer (DuPont; est. MW 10⁵-10⁶ amu, pKa≃−6) that conducts hydrogen ion and other cations (e.g., Na⁺, K⁺, Cs⁺), but which does not conduct either electrons or anions. Its superior hydrogen ion conductivity, superacidity, and hydrophilicity are due to terminal sulfonic acid groups grafted to its teflon backbone via perfluorovinylether links. Protons in the sulfonic acid (SO₃H) groups “hop” group-to-group to create H⁺ current; its matrix pores allow the transport of cations and water. Annealed (in some examples T=80-140° C.), Nafion sets and becomes nearly insoluble in water or standard aqueous acids. PFTDA (Aldrich; MW=714 amu) is a linear perfluorocarboxylic acid, chosen as the chemical complement for Nafion because it has a similar perfluoro carbon backbone and is also insoluble in water but miscible in Nafion and soluble in light alcohols for purposes of blending and spin coating. PFTDA is a carboxylic acid, weak compared to Nafion's sulfonic acid, therefore the Nafion-PFTDA blends may be chemically different from pure Nafion, especially with respect to acidity. For purposes of blending and spin coating, PFTDA was dissolved in isopropyl alcohol (5% PFTDA by weight) to match that of commercial liquid Nafion 1100 (Ion Power LQ-1105, 5% nafion by weight). The HDD membranes (total thickness≃25 microns) were built up from multiple spin-coated layers of various solution blends of nafion and PFTDA (spin coater: Instras model STV3S). For some examples, a membrane consisted of (in order): four layers of pure Nafion (100-0), two layers of 80% nafion and 20% PFTDA (80-20 blend), two layers of 50% nafion and 50% PTFA (50-50 blend), and then four layers of 33% nafion and 67% PFTDA (33-67 blend). Each layer was roughly 500 nm thick. For mechanical stability, thin polycarbonate filters were incorporated into the top and bottom layers of the membrane (Sterlitech, 25 mm diameter, 9μ thick, 0.6μ holes, 8% open area). Once dry, the membrane was clamped tightly between aluminum plates and annealed at 105° C. in dry air for one hour. Higher temperatures may be suitable Nafion annealing, but the higher temperatures may risk evaporating the PFTDA, which has a relatively low melting point (Tₘₑₗₜ ≃132° C.). For these experiments the ratio of Nafion to PFTDA was kept relatively high (33:67 at lowest) to assure the membrane's matrix was within Nafion's proton-percolationregime. The walls of each reservoir were lined with roughly 2-3 micron thick layers of either 100-0 or 33-67 blend, matching the membrane compositions facing them. Before installing them, the membranes and linings were soaked overnight in 0.1 M hydrochloric acid (HCl) to load them uniformly with hydrogen ions, as is standard practice with Nafion-based fuel cells. Reservoirs were then filled with 15 ml of pH 3 HCl. As suggested earlier, the hydrogen ion load in the HDD cells was distributed roughly evenly between the liquid and solid phases. At pH 3, 15 ml of HCl contains 15 moles of hydrogen ions; the theoretical H⁺ load for the reservoir walls and membrane was comparable. The cells had dorsal holes to accommodate salt bridges and pH probes. Salt bridges consisted of teflon tubes (ID either 0.23 cm or 0.64 cm) filled with 3M potassium chloride (KCl) solution in 2%-agarose gelatin (Pierce). A fine-tipped AgCl-based pH electrode (Hanna model HI-1083P) was inserted to monitor the hydrogen ion concentration. When not in use, the dorsal holes were sealed tightly with teflon plugs to minimize evaporation. The pH of each reservoir was measured daily. The pH probe was calibrated before each set of measurements as per the manufacturer's recommendations and cross checked against a sample of the original stock HCl to detect probe drift.

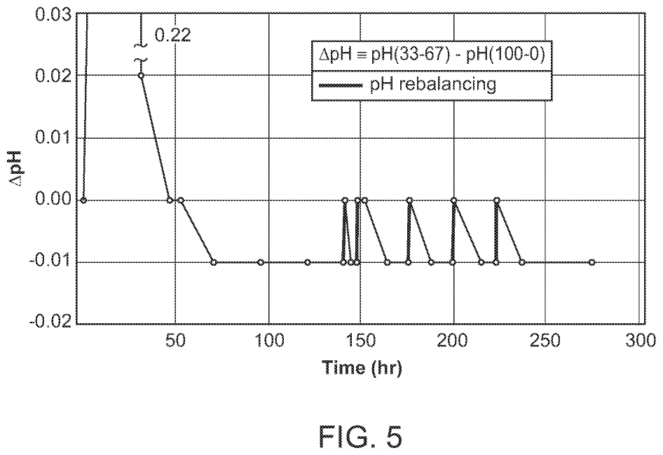

The experimental results for single-membrane HDD are as follows. The single-membrane HDD successfully separated mono-pH solutions into different pH solutions. FIG. 5 presents the pH difference between the two reservoirs of a one membrane HDD cell (ΔpH ΔpH(2)−ΔpH(1)) as a function of time, where 1 and 2 refer to the left and right reservoirs in FIG. 4A. The two solutions began at ΔpH=0.00 (t=0), because the same HCl solution was loaded into both. Initially, the ΔpH increased rapidly (maximum recorded value: ΔpH=0.22) to a fractional difference of 0.66 in hydronium ion concentration. This pH pulse was probably due to more hydronium ions diffusing out from the 100-0 surfaces than from the 33-67 ones; both were pre-soaked in pH 1 HCl, whereas the test solution was merely pH 3. Upon peaking, the ΔpH declined to zero and then by 70 hr declined further to ΔpH=−0.01 and stabilized there, apparently reaching equilibrium. To be clear, ΔpH=−0.01 indicates that hydrogen ion concentration in reservoir 2 (33-67) was roughly 2% higher than in reservoir 1 (100-0). Nafion is a superacid with sulfonic acid groups, whereas PFTDA comprises the relatively weak carboxylic acid. The pure Nafion in the left side of the central membrane and reservoir 1 protonates the weaker acid nafion-PFTDA blend in reservoir 2. This is illustrated by the evolution from open circle dots to solid dots in FIG. 3B; it is also predicted by the non-ideal solution model discussed herein, assuming 1>>α>β in Equations 3 and 4. The time interval 140 hr≤t≤250 hr demonstrates ΔpH reversion. At t=141 hr, the ΔpH=−0.01 was manually nulled (rebalanced) by withdrawing the solutions from both reservoirs, thoroughly mixing them, then refilling the reservoirs with the mixed common acid. Upon nulling ΔpH=0.00 was immediately registered (indicated by the bold vertical line in FIG. 5), however, ΔpH=−0.01 returned within a few hours. This pH rebalancing (nulling) was carried out five times over roughly 80 hours and the ΔpH=−0.01 returned each time. To summarize: (i) the equilibrium ΔpH corresponds to a 2% difference in [H⁺] between reservoirs 1 and 2; and (ii) the ΔpH recurred spontaneously without work input to the system, presumably via thermal diffusion of H⁺ through the membrane.

In theory one can run an electrochemical concentration cell from them, extracting electrical work until their ΔpH is exhausted. When the equilibrated solutions are inserted back into reservoirs 1 and 2 and their ΔpH is restored, as indicated in FIG. 5, the system has completed a thermodynamic cycle, one by which electrical work has been performed. Consideration of the first law of thermodynamics implies that the electrical work performed may have come from another thermodynamic energy source available—heat—in which case the full thermodynamic cycle has converted a quantity of heat into work. In principle, this cycle can be repeated indefinitely. The single-cell, single-membrane HDD experiment (FIG. 4A) and a control (pure Nafion membrane) were replicated by Pacific Integrated Energy (PIE) at comparable pH's and temperatures using apparatus and materials. These experiments corroborated the central findings detailed above, namely, that the asymmetric HDD membrane is a necessary and sufficient condition to spontaneously establish (and re-establish) an equilibrium ΔpH between two acid solutions. Significant deviation between the results was one set of experiments recorded a larger average ΔpH than another set, specifically, ΔpH=−0.027 (PIE) versus ΔpH=−0.01 (University of San Diego). This discrepancy might be explained in part by the higher resolution pH meter used during the first set of experiments (±0.001 pH units) compared with that used during the second set (±0.01 pH units). In summary, experiments indicate that the HDD membrane is a necessary and sufficient condition for non-zero ΔpH between the reservoirs. Wall composition might be helpful in supporting the ΔpH, but by itself it appears insufficient.

### Example 2: Series HDD Cell

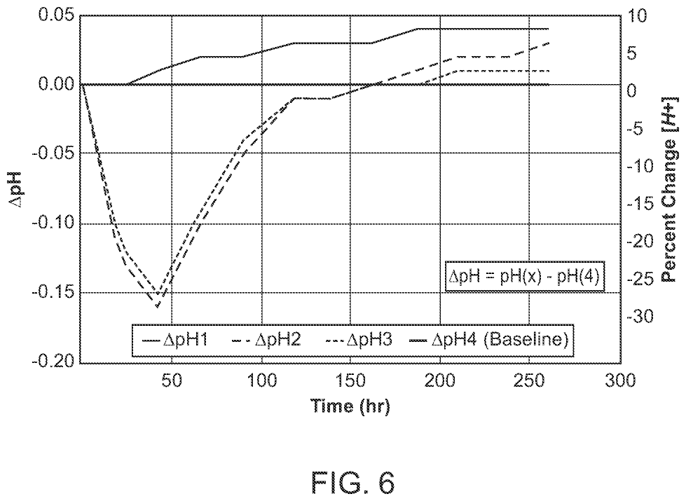

The single-membrane HDD cell spontaneously generated and regenerated non-zero ΔpHs between the cell's reservoirs. however, to be practical and for pH measurements to rise convincingly above the resolution limit of the pH meter (ΔpH ≃0.01), the ΔpH may be larger. Certainly, a number of system parameters might be optimized to accomplish this, including acid type, initial pH, and temperature; membrane com-position, structure, and net thickness; reservoir length and geometry; solvent type and active ion species. An HDD cell was constructed (FIG. 4A). Four teflon reservoirs, identical to the two-reservoir ones (FIG. 4A), were assembled in series. Their three membranes were identical to each other and were the same as those in the one-membrane HDD sans the 80-20 layers; the initial acid load was also the same (15 ml, pH 3 HCl); however, the cylinder walls were not coated, except for discs at the assembly's ends. Upon completion of decay of initial transients, the series diode may evolve to an equilibrium state in which [H⁺] increased with reservoir number (1→4). Specifically, because [H⁺] increased roughly 2% for the single-membrane case (FIG. 4A), the concentration change between reservoirs 1 and 4 in the three-membrane series arrangement was predicted to evolve to (1.02)³≃1.06, a roughly 6% difference in [H⁺]. Accounting for the resolution of the pH meter, the ΔpH between reservoirs 1 and 4 was expected to be in the range 0.02≤ΔpH≤0.05. The [H⁺] may progressively increase from Reservoir 1→4 (or, equivalently, progressively decrease in pH). Measurements confirmed these predictions. FIG. 6 plots the temporal development of ΔpH for the four reservoirs in the three-membrane series configuration (FIG. 4B). Here ΔpH≡pH(x)−pH(4), with x=1,2,3,4 indicating the four reservoirs. By definition, ΔpH(4) forms the zero baseline (solid-flat line), with reservoir 1-3 data lines moving with respect to it. The pH of reservoir 1 (solid line) slowly rises over time to ΔpH=+0.04, indicating a roughly 10% decrease in [H⁺] relative to reservoir 4. The pHs of the central reservoirs (2 and 3, short-dashed line and long-dashed line) initially fall, then rise, cross, and ultimately complete the predicted pH ladder, corresponding to a sequential increase in [H⁺] from reservoirs 1 to 4. This experiment indicates that hydronium concentrations can increase in series HDD cells, indicating that substantially larger ΔpHs (and concentration cell emfs) can be attained with additional stacking.

### Example 3: HDD Concentration Cell Battery

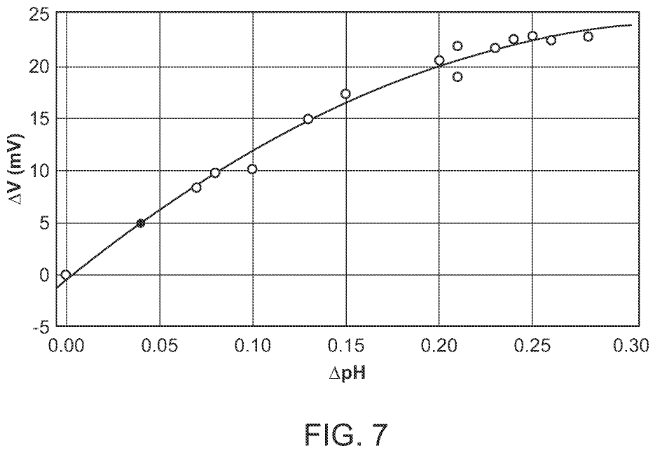

The ΔpH created by the three-membrane series HDD cell was used to generate electricity in an Ag—AgCl concentration cell battery (FIG. 4C). The AgCl battery consisted of two teflon cylinder reservoirs (Length=3.2 cm, O.D.=3.6 cm, I.D.=1.3 cm), each holding 5 ml of acid. Between the reservoirs was clamped a 25 micron thick pure Nafion membrane (with two polycarbonate filters for reinforcement) similar to one that might be used in a hydrogen fuel cell. Roughly 5 mm from the membrane were situated two AgCl square foil electrodes (Aldrich, Ag foil (99.9% pure), 0.95 cm×0.95 cm, thickness=0.1 mm), as depicted in FIG. 4C. The foil squares were spot-welded to 0.5 mm diameter Ag wire leads (Aldrich, 99.9% pure, 0.5 mm diameter) leading out of the cell. Thin layers of AgCl were deposited on the silver electrodes and wire leads by treating them in Clorox for 30 minutes. The AgCl battery is based on the same half-reactions by which the reference electrodes in pH meters measure chloride ion concentration, namely: (a) Ag⁺+e⁻ [symbol] Ag(s); and (b) AgCl(s)+e⁻ [symbol] Ag(s)+Cl⁻. In HCl, the hydrogen and chloride ion numbers are the same so Cl⁻ is a proxy for H⁺. The AgCl battery had no salt bridge. As in FIG. 4C, H⁺ ions passed from the high H⁺-concentration reservoir (4) across the nafion membrane to the low W-concentration reservoir (1). Electrostatic quasi-neutrality was enforced by electron current from one electrode to the other via the external circuit (voltmeter or ammeter). The concentration cell open-circuit emf was measured by a nanovoltmeter (Keithley model 2182) and its output current by a picoammeter (Keithley model 487). The battery was calibrated by manually varying the ΔpH between the two reservoirs, over the range ΔpH=0.30 (roughly a factor of two in [H⁺]), starting at pH 2.89. FIG. 7 presents the output emf of the AgCl battery versus the ΔpH between battery reservoirs under two scenarios. The open circle dots correspond to the battery calibration test, while the solid dot corresponds to the open-circuit emf (voltage) of the cell when the electrolytes from reservoir 1 and 4 of the 3-membrane hydronium diode (FIG. 4B) were placed in the battery. The HDD cell's emf falls closely along the calibration curve. The HDD battery stably generated 1 μA of current and displayed a maximum instantaneous current of 5 μA. The cell was run continuously for 24 hours and its emf and current declined as its ΔpH was exhausted (from ΔpH=0.04 to 0.01). The HDD's parameter space is considerable. Among its many variables are: a) reservoir acidity and acid type; b) membrane thickness, composition, and layering structure; c) alternative ions (e.g., Na⁺, K⁺) and solvents; d) cell size, thickness, and geometry; and e) tests of practical applications, e.g., water desalinization and perpetual batteries.

### Example 4: Prophetic Example of a Parallel Device

This example serves as a prophetic example of thermally driven diffusion diode arranged in parallel for separating a mixture into its components. In FIG. 4B, reservoirs and membranes are arranged in series for concentrating a chemical species. In contrast, the parallel device as shown in FIG. 8 consists of a reservoir 804 for receiving a solution mixture, three chemically asymmetric membranes (CAM) 801-803, where each membrane separately contacts an isolated reservoir 805-807. In this example, a receiving reservoir 804 receives a solution mixture containing three different chemical species, A, B, C. In this example, one CAM 801 is configured to separate species A, one CAM 802 is configured to separate species B, and one CAM 803 is configured to separate species C, from the mixture containing all chemical species A, B, and C. When the parallel configured thermally driven diffusion diode as shown in FIG. 8 is exposed to ambient thermal energy a net flow of species A, B and C is set up, flowing through CAMS 801-803 into reservoirs 805-807, and occurs until chemical equilibrium is reached. At chemical equilibrium the concentration of species A, B, and C is greater in reservoirs 805-807, respectively, as compared to each of the original concentrations of chemical species A, B, and C, respectively as received in reservoir 804.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A membrane comprising:
a. a matrix;
b. a plurality of binding sites, attached to, or contained within, said matrix, wherein said plurality of binding sites are configured to bind a chemical species, and
wherein said matrix or said plurality of binding sites form a chemical potential gradient, and wherein said chemical potential gradient is configured to transport said chemical species in a net direction along said axis of flow via thermal diffusion.

2.-170. (canceled)
